(19) United States
(12) Patent Application Publication
(10) Pub. No.: US 2025/0369421 A1
(43) Pub. Date: Dec. 4, 2025

(54) METHOD FOR PROVIDING A REACTIVE POWER BY WAY OF A WIND FARM CONTAINING MULTIPLE WIND POWER INSTALLATIONS

(71) Applicant: Wobben Properties GmbH, Aurich (DE)

(72) Inventors: Kaveh MALEKIAN BOROUJENI, Bremen (DE); Kai BUSKER, Großefehn (DE)

(73) Assignee: Wobben Properties GmbH, Aurich (DE)

(21) Appl. No.: 19/170,377

(22) Filed: Apr. 4, 2025

(30) Foreign Application Priority Data
Apr. 4, 2024 (EP) 24168477.8
Dec. 30, 2024 (EP) 24223621.4

(51) Int. Cl. F03D 7/04; H02J 3/00; H02J 3/46

(52) U.S. Cl. CPC F03D 7/048; H02J 3/001; H02J 3/46; F05B 2270/1033; F05B 2270/337; H02J 2300/28

(57) ABSTRACT

The disclosure relates to a method for providing a farm reactive power by way of a wind farm containing multiple wind power installations, comprising the steps of receiving a farm target value, which characterizes or influences a farm reactive power, used to specify a reactive power to be fed in by the wind farm, determining a farm control setpoint as a common target value for all wind power installations as a function of the farm target value, determining an individual installation control setpoint in each case for one of the wind power installations as a function of the farm control setpoint, determining and outputting an individual installation reactive power or an individual reactive current in each case by way of one of the wind power installations as a function of an installation voltage difference in the form of a difference between an installation actual voltage and an individual installation voltage setpoint of the respective wind power installation, where the individual installation voltage setpoint is determined from the individual installation control setpoint of the respective wind power installation, or corresponds to the individual installation control setpoint, and where the individual installation control setpoint is determined in each case as a function of the individual installation reactive power of the respective wind power installation and as a function of multiple, in particular all individual installation reactive powers of the wind power installations of the wind farm.

### TECHNICAL FIELD

The present disclosure relates to a method for providing a reactive power by way of a wind farm containing multiple wind power installations. The present disclosure furthermore relates to a corresponding wind farm.

### BACKGROUND

Wind farms are known and feed electric power from wind into an electrical supply grid. Wind farms may be understood here to be power plants, which may also have a significant influence on grid stability and may accordingly be used for grid support purposes. A grid operator may, inter alia, place specifications on the wind farm, which it is intended to implement accordingly.

Such a specification may be a desired reactive power that the farm is intended to feed in as a whole. Such a specification may be specified dynamically, meaning that it is not so much a one-off specification, but rather one that may change, specifically in particular depending on the current needs of the electrical supply grid and thus of the grid operator.

Such a common reactive power value for the wind farm must then be distributed across the individual wind power installations. One possibility would be to distribute this reactive power evenly across all wind power installations, such that, for example, in the case of 10 wind power installations in the wind farm, each wind power installation has to generate one tenth of the reactive power. However, this could give rise to an inappropriate distribution if the wind power installations are not the same size or are not generating the same amount of power at the present time, for example because one of the wind power installations is smaller than the others, or is temporarily in a slipstream due to another wind power installation or other obstacle.

It may also be considered to transmit respective percentages of the reactive power to the individual wind power installations, where these percentages may relate to the respective nominal power or generated power of the respective wind power installation. Such a percentage is able to be adjusted by increasing this percentage when the specified farm reactive power has not yet been reached, such that all installations then generate more reactive power until the common specified farm reactive power value is reached. Particularly if the percentage refers to the respective nominal power of the wind power installation, the current power production of the wind power installation is not taken into consideration. If the active power currently being fed in from each wind power installation is taken into consideration, then the process of distributing the percentages is subject to constant fluctuation.

In principle, it may also be unfavorable for the wind power installations to output different reactive powers, because this may give rise to an imbalance.

It should also be noted that, when specifying individual reactive power values for the individual wind power installations, it is necessary to consider control dynamics that might not be adapted to the control dynamics of the individual wind power installations for determining and setting reactive power.

One possibility for controlling reactive power may be to specify a voltage setpoint of the farm, that is to say a farm voltage setpoint, which is given to the individual wind power installations, as a function of the specified farm reactive power. The individual wind power installations may then, as a function of a difference between this farm voltage setpoint and the current voltage at the wind power installation in question, specify a reactive current that corresponds simply to this difference multiplied by a gain factor. Such a specification means that each wind power installation is additionally able to react to fluctuations in the grid voltage caused by changed reactive power infeed, because the grid voltage immediately affects the voltage present at each wind power installation.

If the specified total reactive power of the farm is not reached, the farm voltage setpoint may be increased or decreased.

Specifying the total reactive power then gives rise to the problem that due to the reactive power different output voltages may occur at the respective wind power installations in the wind farm due to asymmetries or, in particular, due to connection lines having differing lengths of the respective wind power installation, such that the voltage difference between wind power installations varies, resulting in correspondingly different reactive power values between the installations.

### SUMMARY

The present disclosure is thus based on the object of addressing at least one of the problems described above. In one example, the intention is to provide a solution in which a farm reactive power setpoint to be implemented is distributed across the individual wind power installations of the wind farm so as to achieve an overall situation of the provision of reactive power by the individual wind power installations that is as uniform or balanced as possible. At the very least, the intention is to propose an alternative to previously known solutions.

According to the present disclosure, a method as claimed in claim 1 is proposed. What is thus proposed is a method for providing a reactive power by way of a wind farm containing multiple wind power installations, referred to as farm reactive power. In this respect, what is proposed is a method for controlling a wind farm. The method for providing the reactive power or for controlling the wind farm makes provision to receive a farm target value, which characterizes or influences a farm reactive power, used to specify a reactive power to be fed in by the wind farm. The farm target value may be specified as a farm reactive power setpoint and thereby directly be the reactive power to be fed in, or be specified for example as a phase angle φ or cos (φ) at the grid connection point of the wind farm that is intended to be achieved when a farm reactive power is fed in. A setpoint for the farm reactive power may also be specified or determined based on a recorded voltage, (e.g., at the grid connection point), and a predefined U-Q characteristic curve or Q(U) function that establishes a relationship between recorded voltage and reactive power to be specified. A setpoint voltage may also be specified, and a setpoint for the farm reactive power may be specified or determined as a function of this setpoint voltage (e.g., as a function of a deviation of an actual voltage from the setpoint voltage).

In one example, such a farm target value, for the farm reactive power setpoint, may be specified by a grid operator (e.g., can be specified dynamically). For this purpose, the wind farm may have a farm control unit that has an interface via which a grid operator, a power supply company and/or another person or institution is able to input such a farm target value, such as farm reactive power setpoint. This may be achieved, for the farm reactive power setpoint, by inputting an absolute reactive power value with the unit var. However, it is also possible to input a percentage, which relates for example to a nominal power of the wind farm.

A farm target value may thus be specified as a setpoint from the grid operator. Such a setpoint from the grid operator may thus be a phase angle φ or cos (φ), or directly a value for a reactive power. In addition, it is possible for the farm reactive power setpoint to be ascertained from a Q(U) function specified by the grid operator. Such a Q(U) function or the value respectively determined depending thereon may form the farm target value. Ultimately, the farm reactive power setpoint may be ascertained from such external setpoints.

As a function of this farm target value or farm reactive power setpoint, a farm control setpoint is determined as a common target value for all wind power installations as a function of the farm target value. The farm control setpoint may be a voltage setpoint or a reactive power setpoint. In on example, if it is determined as a reactive power setpoint, it may also be specified as a relative value (e.g., as a percentage). A nominal power (e.g., nominal active power or nominal reactive power of the wind farm), may be selected as a reference variable. A reactive power setpoint of 50% would therefore mean that reactive power should be fed in at a level of half the nominal reactive power of the wind farm.

If it is specified as a farm reactive power setpoint, a farm voltage setpoint may be determined depending thereon as a common voltage setpoint for all wind power installations. The common voltage setpoint then forms the common target value. Such a farm voltage setpoint—if it were not modified in the manner explained further below—could then be present at each wind power installation, which then in each case independently attempts to adjust a difference between such a farm voltage setpoint and the current voltage at the wind power installation. The voltage at the respective wind power installation is, in one example, a voltage at the connection terminals of the respective wind power installation.

If the common target value is not in the form of a voltage setpoint, however, a respective voltage setpoint may be determined therefrom, as explained further below. It is then also possible to attempt to adjust a difference between a farm voltage setpoint and the current voltage at the wind power installation.

Such a voltage difference may be adjusted by virtue of the respective wind power installation using a P controller. The difference between the farm voltage setpoint and the voltage at the connection terminals of the respective wind power installation is thus multiplied by a proportionality factor, and the result is, in one example, a reactive current generated and output by the wind power installation in question. It is thereby accordingly possible to increase or reduce the voltage present at the wind power installation, but there may be a remaining control deviation due to the use of such a P controller. Such a control deviation is also desirable here, because the aim is not that of adjusting this voltage difference completely, but rather that of achieving individual reactive power generation or reactive current generation for each wind power installation via such a voltage difference.

However, it is now proposed for an individual installation control setpoint, in one example installation voltage setpoint, to be determined in each case for one of the wind power installations as a function of the farm control setpoint. In one example, the farm control setpoint is changed individually for all wind power installations, as a result of which the individual installation control setpoint is determined in each case for each wind power installation.

If the installation voltage setpoint is determined, this is done as a function of a common voltage setpoint, namely the farm voltage setpoint. In one example, each wind power installation thus receives an individual installation voltage setpoint based on the common voltage setpoint. In other words, the common voltage setpoint, that is to say the farm voltage setpoint, is modified individually for each wind power installation.

An individual installation reactive power or an individual reactive current is then determined and output in each case by one of the wind power installations as a function of an installation voltage difference in the form of a difference between an installation actual voltage and the individual installation voltage setpoint of the respective wind power installation. Determining the individual installation voltage setpoint thus makes it possible, for each wind power installation, to individually influence the level of the reactive power or reactive current of each wind power installation.

For this purpose, provision is made for the individual installation control setpoint to be determined in each case as a function of the individual installation reactive power of the respective wind power installation and as a function of multiple, in one example, as a function of all individual installation reactive powers of the wind power installation of the wind farm. The individual installation voltage setpoint, which may correspond to the installation control setpoint or is determined therefrom, thus also depends on the individual installation reactive power and the reactive powers, in one example, of the other wind power installations. A relationship is, in one example, established here between the individual installation reactive power and the other installation reactive powers. The relationship may, in one example, be established between in each case an individual installation reactive power and an average or a mean of all or at least the other installation reactive powers.

A relationship is thus established between the individual installation reactive power and the overall situation of the wind farm with regard to reactive power, that is to say, in one example, the relationship with the average of all installation reactive powers. This relationship thus influences the individual installation voltage setpoint, and this influences the generation of the installation reactive power of the installation in question. It is thereby possible to adapt the installation reactive power, in one example, to the average of all or the other installation reactive powers of the wind farm. This in turn makes it possible to achieve balancing of the generated installation reactive powers.

One advantageous aspect of this method is that it is possible, in any wind power installation, to use a reactive power controller that does not need to be adapted for the desired balancing. It is possible to achieve the balancing by virtue of each reactive power controller of the wind power installation receiving only an adapted voltage setpoint, namely the individual installation voltage setpoint. This also depends here on the common target value, in one example, voltage setpoint, that is to say the farm voltage setpoint. If the specified farm target value, in one example farm reactive power setpoint, is changed, this results in a change in the target value. Furthermore, a change in the common voltage setpoint, for example the farm voltage setpoint, can have an immediate influence on each individual installation voltage setpoint.

By way of example, if the farm reactive power setpoint thus increases, the farm voltage setpoint may increase accordingly, and the individual installation reactive power of each wind power installation may thus also increase immediately. In one example, when using a reactive power controller in each wind power installation with P control behavior, this reactive power or reactive current increase may also take place immediately.

The balancing achieved by determining the individual installation voltage setpoints is initially unchanged here. It may also potentially be adapted to the changed situation, that is to say to the changed farm target value, in one example, farm reactive power setpoint, but this is not so time-critical because the increase in the individual installation reactive powers and thus also the increase in the farm reactive power has already essentially taken place. It may even have already taken place completely, because the balancing carried out by changing the individual installation voltage setpoints ideally only changes the internal distribution of the generated reactive power in the wind farm, and not the total reactive power provided by the farm, which may also be referred to as farm reactive power.

According to one aspect, it is proposed for the farm target value to be specified as a farm reactive power setpoint, and/or for the farm control setpoint to be determined as a farm voltage setpoint used to specify a voltage as a common target value for all wind power installations, and for the individual installation control setpoints to be determined as individual installation voltage setpoints.

According to this aspect, the method thus makes provision, in order to provide the reactive power or to control the wind farm, to receive a farm reactive power setpoint as a specification of a reactive power to be fed in by the wind farm.

A farm voltage setpoint in the form of a common voltage setpoint is determined for all wind power installations as a function of this farm reactive power setpoint. Such a farm voltage setpoint could then be present at each wind power installation, which then in each case independently attempts to adjust a difference between such a farm voltage setpoint and the current voltage at the wind power installation.

However, it is now proposed for an individual installation voltage setpoint to be determined in each case for one of the wind power installations as a function of the common voltage setpoint, that is to say the farm voltage setpoint. In one example, each wind power installation thus receives an individual installation voltage setpoint based on the common voltage setpoint. In other words, the common voltage setpoint, that is to say the farm voltage setpoint, is modified individually for each wind power installation.

An individual installation reactive power or an individual reactive current is then determined and output in each case by one of the wind power installations as a function of an installation voltage difference in the form of a difference between an installation actual voltage and the individual installation voltage setpoint of the respective wind power installation. Determining the individual installation voltage setpoint thus makes it possible, for each wind power installation, to individually influence the level of the reactive power or reactive current of each wind power installation.

For this purpose, provision is made for the individual installation voltage setpoint to be determined in each case as a function of the individual installation reactive power of the respective wind power installation and as a function of multiple, in one example, as a function of all individual installation reactive powers of the wind power installation of the wind farm. The individual installation voltage setpoint thus depends on the individual installation reactive power and the reactive powers, in one example, of the other wind power installations. A relationship is, in one example, established here between the individual installation reactive power and the other installation reactive powers.

According to one aspect, it is proposed for the farm target value to be received as a farm reactive power setpoint, or for a farm reactive power setpoint to be determined from the farm target value, if the farm target value is not a farm reactive power setpoint, for a modified farm reactive power setpoint to be determined from the farm reactive power setpoint using a controller, in one example, using a PI controller, or a controller having a PI component, and for the farm control setpoint to be determined as a function of the farm target value by determining the farm control setpoint as a function of the modified farm reactive power setpoint.

It is therefore proposed here to modify the farm reactive power setpoint using a controller, regardless of whether the farm reactive power setpoint is received directly or is determined for the first time from other target values, and/or regardless of whether the farm control setpoint is determined as a farm voltage setpoint or as a farm reactive power control setpoint.

The controller determines the modified farm reactive power setpoint, that is to say outputs it as the result of the control process. It is thereby possible to adjust a control error between the farm reactive power setpoint and the farm reactive power actual value.

The idea here is for the wind farm itself to consume reactive power, such that, of the reactive power generated in the farm, less thereof is able to be provided at the grid connection point. The recorded farm reactive power then does not reach the specified farm reactive power; a control error occurs. The control error has the result, in the PI controller, that the modified farm reactive power setpoint increases until it is higher than the unmodified farm reactive power setpoint by a difference that corresponds to the reactive power consumed in the farm.

The PI controller may be limited as a function of a nominal power and/or maximum reactive power. In one example, the PI controller may be limited to a maximum reactive power of the wind farm. The limitation may be such that its I component is limited, or it may include same. This prevents the I component from being further integrated without limitation if the reactive power setpoint is not reached.

According to one aspect, it is proposed for the farm control setpoint to be determined as a farm reactive power control setpoint used to specify a reactive power as a common target value for all wind power installations, and for the individual installation control setpoints to be determined as installation reactive power setpoints.

This is an alternative implementation of the proposed method, in one example, with regard to the aspect of determining a farm control setpoint as a farm voltage setpoint. Here, the farm target value is converted into a farm reactive power control setpoint that specifies a common reactive power instead of a voltage. The reactive power, as a common target value, is then distributed into individual installation reactive power values. This may take place at the farm level.

The individual installation voltage setpoints are thus determined from individual installation reactive power values. The conversion of reactive power setpoints into voltage setpoints therefore takes place later compared to the previous aspect. The wind power installations may receive these individual installation reactive power values, and only then do the wind power installations determine the individual installation voltage setpoints therefrom.

According to this aspect, the individual installation voltage setpoints are thus determined only later, in one example, for the first time in the respective wind power installation, whereas they were received by the wind power installations as input values according to the aspect of determining a farm control setpoint as a farm voltage setpoint.

The installation reactive powers are then determined based on the installation voltage setpoints, and this is the same in both aspects. The determination of the installation reactive powers based on the installation voltage setpoints is therefore independent of whether the installation voltage setpoints according to this aspect were determined for the first time from the installation reactive power setpoints, in one example, for the first time in the wind power installation, or, according to the previous aspect, the installation voltage setpoints were determined outside the wind power installation and transmitted to the wind power installation, and in one example, the transformation of reactive power setpoints to voltage setpoints already took place earlier.

In both aspects, the individual installation voltage setpoints may each be determined as a function of the individual installation reactive power of the respective wind power installation and as a function of multiple, in one example, all individual installation reactive powers of the wind power installations of the wind farm, either directly or indirectly.

According to one aspect, it is proposed for the respective installation voltage setpoint to be determined at each of the wind power installations from the respective installation control setpoint, in one example, when this is determined as an installation reactive power setpoint, in one example, by way of a control value transform unit.

The installation voltage setpoints are thus each determined at the wind power installation, in one example, by way of an installation controller of the wind power installation in question. The control value transform unit may be part of the installation controller, in one example, be implemented as a function block therein.

According to one aspect, it is proposed for the installation voltage setpoint to be determined from each installation control setpoint, in one example, when this is determined as an installation reactive power setpoint, in each case using a control value transform function, and for the control value transform function to have at least one of the following properties.

One possible proposed property of the control value transform function is that the control value transform function has a low-pass behavior having at least one first main low-pass time constant, where in one example, the first main low-pass time constant has a value in the range of 100 ms to 500 ms. It is therefore proposed for the installation reactive power setpoint to be transformed into the installation voltage setpoint with a low-pass behavior. A first-order low-pass behavior, that is to say a PT1 behavior, may be sufficient. Its time constant is then the main time constant. In higher-order low-pass filters, the largest time constant may be considered to be the main time constant.

It has been taken into consideration here that the setpoint may thus be filtered, but this does not influence the speed at which the setpoint is converted into the reactive power or reactive current.

One possible proposed property of the control value transform function is that the control value transform function determines the installation voltage setpoint independently of an installation actual voltage. This makes it possible to achieve good decoupling between the specification and ambient conditions. The transformation may, in one example, thereby be implemented as a pure control process. It should be noted in this regard that there may be a very large number of wind power installations in the wind farm and a correspondingly large number of control value transform functions work in parallel, these thereby also being decoupled from one another.

One possible proposed property of the control value transform function is that the control value transform function limits a gradient of the installation voltage setpoint to a specified gradient limit value. It is thereby possible to avoid excessive changes in reactive power without intervening in the control of the conversion to do so. The proposed limitation is therefore positive for stability.

One possible proposed property of the control value transform function is that the control value transform function limits an amplitude of the installation voltage setpoint to a specified amplitude limit value. This, in one example, avoids an installation reactive power setpoint that is determined as being excessively high being converted into an excessively high voltage setpoint that the corresponding controller is not able to implement in the wind power installation. This avoids any request for an excessively high reactive current that could undesirably limit the active current to be fed in. The restriction provided by the control value transform function may be good for stability, as it does not interfere with the implementation in the controller.

According to one aspect, it is proposed for in each case one of the wind power installations to have its installation control value limited. A predetermined reactive power maximum value may be specified for this purpose, or a predetermined reactive power minimum value may be specified for negative reactive powers. It is possible to specify, as a specification, fixed values, or values depending on an operating point of the wind power installation in question, in one example, as a function of an active power fed into the operating point. A P-Q diagram may be taken as a basis for this, said P-Q diagram having reactive power limits, in one example, in the form of graphs, as a function of the active power output by the wind power installation. The reactive power limits indicate the respective reactive power maximum value or reactive power minimum value as a function of the active power currently being fed in. Depending on the active power of the current operating point, it is thus possible to read a current reactive power maximum value and/or reactive power minimum value from the P-Q diagram and use it for limitation purposes.

In one example, an increase in the installation control setpoint thereof is prevented if the individual installation reactive power output thereby or individual reactive current output thereby has reached a predetermined maximum value, which in one example, indicates a value that the individual installation reactive power or the individual reactive current is not able to or permitted to exceed. This results in a limitation, but said limitation depends on the output reactive power or the output reactive current. It has been recognized here that it is necessary to limit the setpoint only when it is no longer possible or advantageous to implement it. It is thereby possible to limit the reactive power output without implementing the limitation in the corresponding control to be implemented.

For this purpose, provision is made, in one example, for the individual installation reactive power output in each case or the individual reactive current that is output to be recorded and checked to determine whether the predetermined maximum value is reached and, if the predetermined maximum value is reached, for the increase in the installation control setpoint to be prevented, in one example, the installation control value and/or an offset that influences the installation control value to be frozen until the predetermined maximum value has been fallen back below. The reactive power or reactive current may thereby be brought to the maximum value, but without implementing any limitation in terms of control.

According to one aspect, it is proposed for the individual installation control setpoint, in one example, the installation voltage setpoint, to be determined from the farm control setpoint, in one example, the farm voltage setpoint and an individual control correction value, in one example, voltage correction value. The control correction value or voltage correction value may be subtracted from the farm control setpoint or farm voltage setpoint for this purpose. For this purpose, it is furthermore proposed for the individual control correction value, in one example, voltage correction value, to be determined as a function of an average difference (e.g., from an average difference), where the average difference denotes a difference between the respective individual installation reactive power and an average of all individual installation reactive powers.

An average is thus determined from individual installation powers. In one example, all individual installation reactive powers are summed and divided by the number of wind power installations. The control correction value, in one example, voltage correction value, is thus greater in terms of absolute value the more the installation reactive power of the respective wind power installation in question deviates from the average installation reactive power of all wind power installations in the wind farm. Accordingly, for the respective wind power installation, the farm control setpoint or farm voltage setpoint is also modified to a greater extent the greater the individual control correction value or voltage correction value. The principle is equally applicable when implementing installation control setpoints in the form of installation reactive power setpoints and farm control setpoints in the form of farm reactive power control setpoints. In this case, the reactive power setpoints are converted into voltage setpoints later, such that the modification takes place at the reactive power level using the control correction value. For this purpose, the individual control correction value may be in the form of an individual reactive power correction value. Further explanations based on modifications of the voltage setpoints should be applied accordingly in the same way to other implementations, in one example, the other implementation described that uses the reactive power setpoints.

Applications that are described for installation voltage setpoints, farm voltage setpoints and/or voltage correction values should also be understood to be representative of other applications to installation control setpoints, farm control setpoints and/or control correction values, in one example, as examples of installation reactive power setpoints, farm reactive power setpoints and/or reactive power correction values.

In one example, it is proposed for the average difference used to determine the individual control correction value or voltage correction value to be given via a controller (e.g., a PI controller). The control correction value or voltage correction value is therefore—as is already apparent due to the different units—not directly the difference between the installation reactive power and the average of all installation reactive powers, but rather this difference is managed via a controller. If the controller is a PI controller, the difference is thus multiplied firstly by a controller gain and integrated in parallel therewith by an integrator. It is thereby possible to achieve steady-state accuracy for the respective deviation of the individual installation reactive power from the average of the other installation reactive powers, and the deviation is thus able to be adjusted completely.

In addition, such a PI controller may be used to specify or influence controller dynamics. Provision may in particular be made to adapt the controller dynamics of such a controller to controller dynamics of a farm controller that specifies the farm voltage setpoint as a function of the farm reactive power setpoint.

It should be noted that, in the exemplary case of the PI controller, it is possible to achieve steady-state accuracy for the respective individual installation reactive power values. It is therefore possible to achieve a situation whereby all individual installation reactive power values are identical. It should be noted that said PI controller does not result in a voltage difference between the respective individual installation voltage setpoint and the voltage recorded at the wind power installation in question being achieved. A remaining control deviation may still be expected there, in any case if a reactive power controller is configured as a P controller in each individual wind power installation.

It should likewise be noted that each wind power installation may specify a reactive power current by way of its reactive power controller, but the individual installation reactive power is considered in order to determine the individual control correction value or voltage correction value. The reactive power controller of each wind power installation may thereby be used to specify a reactive current using the phase position of the output current in each case, while the reactive power actually output is however considered for balancing. Differences between the consideration of reactive current and reactive power may occur here, for example, in the case of different installation voltages, that is to say the voltages present at each of the connection terminals of the wind power installation.

According to one aspect, it is proposed for the individual control correction value, in one example, voltage correction value, to be determined as a function of an individual installation offset for the respective wind power installation. Provision is in one example, made here for the individual control correction value or voltage correction value to be determined not solely as a function of the deviation of the reactive power of the respective wind power installation from an average, but rather for this individual installation offset to provide the possibility of further intervention. This installation offset thus provides a further degree of freedom. It may, in one example, be added to the deviation.

It is therefore proposed in one example, to take into consideration the described average difference, this being determined in the form of a difference between the respective individual installation reactive power and an average of all individual installation reactive powers. This average difference is therefore still used as a basis and may be changed by the respective installation offset.

Provision is made in one example, for the individual control correction value or voltage correction value to be determined as a function of the average difference and the individual offset, such that the individual installation offset is in each case added to the average difference in order to determine a modified average difference and, in one example, for the modified average difference used to determine the individual control correction value or voltage correction value to be given via a or the controller (e.g., a PI controller).

This makes it possible to retain the previous structure used to determine the control correction values or voltage correction values. In this described structure, which is also described in part below, only the respective individual installation offset needs to be connected to the respective average difference.

According to one aspect, it is proposed for the sum of all installation offsets to be zero. This ensures that, despite the specification of the individual installation offsets, which may also be referred to synonymously as installation offsets for simplification, balancing is maintained, or that the sum of all installation reactive powers that are fed in reaches the farm target value, in one example, farm reactive power setpoint.

In addition or as an alternative, it is proposed for the installation offsets to be determined such that installation reactive powers at the wind power installations having different mathematical signs are avoided. The installation offsets may be determined such that a comparison benchmark does not fall below a comparison limit value. This lies in one example, between 0.5 and 0.95, or is 1, where the comparison benchmark is defined by a ratio of the absolute value of a sum of all installation reactive powers that are fed in to a sum of the absolute values of all installation reactive powers.

If reactive powers having different mathematical signs are generated, that is to say capacitive and inductive, this results in a lower sum, in terms of absolute value, compared to the sum of the absolute values. The ratio, that is to say the quotient of both sums, thereby falls below 1 and may reach the value 0 if all installation reactive powers cancel one another out. In the theoretical case of all installation reactive powers being 0, the value 1 is assumed for the ratio, or the comparison benchmark is defined as 1. In any case, the value 1 represents the optimum case for the comparison benchmark, because there are then no installation reactive powers having different mathematical signs. The value I must therefore be striven for through an appropriate selection of the installation offsets. However, if it turns out to be slightly lower, namely in the range of 0.5 to 0.95, this is not optimum, but is better than falling below the value of 0.5.

In addition or as an alternative, the installation offsets are determined such that the comparison benchmark is not smaller, or at least not less than 90% of the comparison benchmark than in the case that all installation offsets are zero. The installation offsets should therefore be selected such that the situation is not worsened or not worsened significantly thereby.

The proposal without the individual installation offsets makes it possible to achieve a situation whereby the reactive powers of all wind power installations are equal due to individual voltage setpoints. The reactive powers of the wind power installation in the adjusted state are thus independent of the actual voltages and the actual active powers of the wind power installations.

The following is now proposed in addition by the individual installation offsets. Namely, it is proposed to influence the distribution of the farm reactive power setpoints between the wind power installations for further optimization purposes by summing a set of offset values. Such optimization purposes may include, inter alia, loss optimization or optimized voltage holding. By way of example, for loss optimization, it may be useful for wind power installations located closer to the grid connection point to be more involved in reactive power provision compared to the other wind power installations.

When determining the offset values for the wind power installation reactive powers, that is to say the installation offsets, it is proposed, in addition to or instead of the optimization purpose, for two other restrictions, or at least one of them, to be taken into consideration:

The sum of all offset values, that is to say all installation offsets, should be equal to zero so that the farm reactive power setpoint is not influenced by the offset values.

The offset values should be selected or ascertained online or offline such that a conflicting combination of the wind power installation reactive powers, that is to say capacitive and inductive reactive powers provided at the same time by different wind power installations, is ruled out, or is at least not significant.

The installation offsets may be fixed values, or may be specified as a function of operating variables such as voltages, average of the installation reactive powers of all wind power installations in the wind farm, active power and reactive power of the individual wind power installations or states. One state, for example one desired state, may be for example the average of the reactive powers of all wind power installations being almost 0. Another state may be when individual wind power installations reach their apparent power limit. States may be derived from recorded variables, which may be ascertained online.

According to one aspect, it is proposed for the individual control correction value, in one example, voltage correction value, which is used to determine the respective individual installation control setpoint, in one example, individual installation voltage setpoint, from the farm control setpoint, in one example, farm voltage setpoint, to be determined in each case such that a sum of all individual control correction values or voltage correction values is zero. In other words, all individual control correction values or voltage correction values are thus determined such that their sum is zero.

This makes it possible to achieve a situation whereby, although the originally specified farm control setpoint or farm voltage setpoint is modified individually, an average of all individual installation control values or installation voltage setpoints remains the same. This is based in one example, on the idea that the in each case individually changed installation control setpoints or installation voltage setpoints, that is to say values that have changed compared to the farm control setpoint or farm voltage setpoint, are each assigned to a correspondingly changed reactive power by the reactive power controller of each installation. The fact that the average of all individual installation control setpoints or installation voltage setpoints remains the same means that it is also possible to achieve a situation whereby the average of all reactive powers remains the same and thus the total reactive power generated by the wind farm, that is to say in other words the sum of all installation reactive powers, remains the same. This makes it possible to achieve a situation whereby the modification of the individual installation control setpoints or installation voltage setpoints actually only influences balancing in the wind farm, but does not change the total reactive power generated by the farm, that is to say the farm reactive power.

This measure whereby the sum of all individual installation control setpoints or installation voltage setpoints is zero is proposed for the solution both with and without individual installation offsets.

According to one aspect, it is proposed for the individual installation reactive power to be determined so as to counteract a voltage difference in the form of a difference between the individual installation voltage setpoint and an installation actual voltage present at the respective wind power installation by setting the individual installation reactive power. The individual installation reactive power may also be achieved by specifying an installation reactive current accordingly. It is in one example, proposed here for a P controller as already described above to be used as a reactive power controller, in which this voltage difference is multiplied by a factor in order thereby to calculate a reactive current or a reactive power. This reactive current counteracts the voltage difference. However, it does not have to be a P controller, but rather a controller other than a P controller may also be used, but the use of a P controller as a reactive power controller has proved to be advantageous here, and has also proved in one example, to be a fast controller.

Using such a reactive power controller, which specifies a reactive power or a reactive current via this voltage difference, together with the individual setting of the individual installation voltage setpoint, it is thus possible to set the installation reactive power to be generated by each individual wind power installation on an individual basis and thereby achieve the desired balancing.

According to one aspect, it is proposed for the wind power installations to each record their output individual installation reactive power as an installation reactive power actual value and transmit it to a central control unit of the wind farm, for use in determining all individual installation control setpoints, in one example, installation voltage setpoints. In one aspect, is also proposed for this purpose for the wind power installations nevertheless to determine a reactive current as a function of their individual installation voltage setpoints.

The installation reactive power actual values recorded and transmitted by the wind power installations are thus combined in the central control unit of the wind farm, and the average of all individual installation reactive powers or installation reactive power actual values may in one example, be determined therefrom. The individual control correction value, in one example, voltage correction value, is determined in one example, from an average difference in the form of a difference between the respective individual installation reactive power and the average of all individual installation reactive powers.

This determination is carried out individually for each wind power installation. The individual installation reactive power assigned to the wind power installation is used in each case here, but the average of all individual installation reactive powers is the same for each wind power installation. It is therefore also proposed in one example, to calculate the average of all individual installation reactive powers, that is to say of the installation reactive powers of all wind power installations, including the wind power installation in question in each case. It is then necessary only to carry out averaging.

The individual installation control values, in one example, installation voltage setpoints such as the individual control correction values or voltage correction values, may likewise be determined in the central control unit. In one example, the individual installation control values or installation voltage setpoints and in one example, the individual control correction values or voltage correction values are each determined in the wind power installation in question. For this purpose, it may obtain the average of all individual installation reactive powers from the central control unit of the wind farm. Aspects of the present disclosure have been developed recognizing that the average of all individual installation reactive powers are to be determined centrally, or even only centrally. It has also been recognized that only this average may be transmitted from the central control unit of the wind farm to the individual wind power installations with little effort.

According to one aspect, it is proposed for the individual installation reactive power to be taken into consideration and/or transmitted in each case as a relative value, in one example, a percentage, with respect to a maximum available installation reactive power of the respective wind power installation or based on a nominal reactive power or nominal active power of the respective wind power installation. It is thereby possible to adapt the level of the individual installation reactive power to the size of the wind power installation.

Aspects of the present disclosure have been developed recognizing that it is possible to increase efficiency by adapting the level of the generated reactive power to the generated active power. This is based on the finding that the generation of reactive power also entails at least some power loss, that is to say active power loss, and would therefore result in a lower efficiency for a wind power installation were it to generate little active power but at the same time have to generate a large amount of reactive power. This would be possible, but not very efficient. This may be avoided by specifying relative values, in one example, percentages.

According to one aspect, it is proposed for the individual control correction value, in one example, voltage correction value used to determine the respective individual installation control setpoint, in one example, installation voltage setpoint, from the farm control setpoint, in one example, farm voltage setpoint, to be able to be limited by specifying a correction limitation. For this purpose, it is proposed, in order to limit the individual control correction values or voltage correction values, for the correction limitation to be applied to all individual control correction values or voltage correction values such that a sum of all individual control correction values or voltage correction values remains the same, in particular remains zero.

It has been recognized here that balancing is able to be limited by specifying a correction limitation. It has been recognized that it is not necessarily useful to carry out balancing to an arbitrary extent. A proposed correction limitation may be advantageous for the following situation. If minimum and maximum limits are defined for individual installation control setpoints or voltage setpoints, namely installation voltage setpoints, these limits may be achieved by way of individual control correction values or voltage correction values for the purpose of balancing in some wind power installations. It is thus not possible to achieve the farm reactive power that is striven for. This case may be avoided by specifying a correction limitation.

Aspects of the present disclosure have been developed recognizing that a limitation may lead to an imbalance, particularly if, in the present case, a limitation would naturally affect only some but not all wind power installations. It is therefore proposed to implement a limitation such that a sum of all individual control correction values or voltage correction values is not changed. In one example, the sum of all individual control correction values or voltage correction values is zero even without limitation, and it is therefore proposed to implement the limitation such that the sum of all individual control correction values or voltage correction values is zero even after the limitation.

This achieves a situation whereby, even when using a limitation, the principle remains that the intended balancing provided by modifying the individual installation control setpoints or installation voltage setpoints as far as possible does not change the total reactive power output by the wind farm. By way of example, it is possible to achieve a situation whereby a sum of all individual control correction values or voltage correction values remains the same by calculating this sum and then, when it changes, in one example, when it leaves the value zero, changing the individual control correction values or voltage correction values such that the sum is returned to zero.

The following exemplary aspect are proposed so that the sum of all individual control correction values or voltage correction values remains the same.

According to one aspect, it is thus proposed, in the case of specifying the correction limitation and if at least one individual control correction value or voltage correction value exceeds the correction limitation, that is to say before it is limited, for a limitation ratio to be formed. This limitation ratio is formed as a ratio between the correction limitation and a maximum control correction value or voltage correction value.

The maximum control correction value or voltage correction value is, in terms of absolute value, the greatest value of all individual control correction values or voltage correction values before they are limited. The ratio between the correction limitation and the maximum control correction value or voltage correction value should be understood to mean a quotient between these two values, that is to say a quotient of the correction limitation divided by the maximum control correction value or voltage correction value.

In the event that at least one individual control correction value or voltage correction value exceeds the correction limitation, the maximum control correction value or voltage correction value naturally also exceeds the correction limitation. The quotient of the correction limitation divided by this maximum control correction value or voltage correction value is thus less than 1.

It is furthermore proposed for each individual control correction value or voltage correction value to be multiplied by the limitation ratio in order thereby to form in each case an individual modified control correction value or voltage correction value. This is then used to determine the respective individual installation control values or installation voltage setpoints from the farm control value or farm voltage setpoint. The farm control setpoint or farm voltage setpoint is therefore no longer modified by the individual control correction value or voltage correction value, but rather by the individual modified control correction value or voltage correction value.

This is based on the idea that the multiplication of the maximum control correction value or voltage correction value by the limitation ratio corresponds to the correction limitation. The maximum control correction value or voltage correction value is thereby thus limited to the correction limitation.

All other control correction values or voltage correction values are changed by the same value as a result of the multiplication by this limitation ratio. This ultimately means that the sum of all individual control correction values or voltage correction values remains zero.

It should be noted here that positive and negative control correction values or voltage correction values occur, because it is only in this way that their sum is able to become zero. When multiplied by the limitation ratio, all control correction values or voltage correction values are reduced in terms of absolute value. Both positive and negative individual control correction values or voltage correction values are thereby reduced in terms of absolute value, such that the sum is able to remain zero.

According to one aspect, it is proposed, in the event of a grid fault occurring (e.g., in an FRT, LVRT or OVRT case) at one, some or all wind power installations, to change statics specifying a relationship between the installation voltage difference and an installation reactive current to be fed in by the respective wind power installation. The statics are thus changed compared to a situation without a grid fault. It is thereby possible to change in one example, a voltage-dependent or voltage difference-dependent reactive power infeed in terms of its dynamics in order thereby to respond to the grid fault.

A situation that may be referred to as FRT, or fault ride through, may be considered in one example, to be a grid fault. This in one example, involves voltage dips, that is to say what is referred to as an LVRT (low voltage ride through) case, or an overvoltage case, in one example, an OVRT (over voltage ride through) case. It is additionally proposed here to specify an installation reactive current as a function of the voltage difference.

In such a case in which the voltage leaves its normal range, this has a strong influence on the reactive power. In one example, in the event of a very large voltage dip, a desired reactive power might no longer be fed in, but a reactive current may still be fed in, and so it is proposed to specify a reactive current. For this purpose, it is possible in one example, to use statics that are adapted accordingly, that is to say changed compared to the case without a grid fault.

In addition or as an alternative, it is proposed, in the event of a grid fault occurring, for the determination of the individual installation reactive power or individual installation reactive current at one, some or all wind power installations to be changed to a simplified alternative method. It has in one example, been recognized here that the proposed balancing may be suspended in such an event of a grid fault. On the one hand, it has been recognized here that balancing is less important in the event of a grid fault. On the other hand, it has been recognized that, in the event of a grid fault, the reactive power specification no longer depends on an externally specified reactive power infeed. On the contrary, there is then a direct and immediate response to the voltage behavior of the electrical supply grid.

It is in one example, proposed for the wind power installation in question to determine in each case an individual installation reactive current as a function of the recorded installation actual voltage present at the respective wind power installation and a fixedly specified voltage setpoint. In one example, the wind power installation in question determines the reactive current as a function of an installation voltage difference in the form of a difference between the installation actual voltage and this fixedly specified voltage setpoint.

The simplified alternative method is thus a method that temporarily makes do without the proposed balancing of reactive power in the wind farm; it is able to work using only statics for each wind power installation. The statics used in each case at the wind power installation describe in one example, a predefined relationship between a voltage deviation at the wind power installation, namely a deviation of the voltage at the wind power installation from a voltage reference value, in one example, a nominal voltage. However, these statics, that is to say this relationship, may also be more complex, for example have levels, such that the relationship has for example different gradients in different ranges of the voltage deviation.

In addition or as an alternative, it is proposed for the wind power installation in question to in each case determine an individual installation reactive current as a function of a reactive current fed in by the wind power installation in question prior to the occurrence of the grid fault. It is thereby likewise possible to provide a simplified method.

In addition or as an alternative, it is proposed for the simplified alternative method to use changed statics that indicate a relationship between a or the voltage difference and the individual installation reactive current. These statics are changed compared to controlling each wind power installation without the simplified alternative method. In one example, steeper statics are provided for the simplified alternative method, that is to say statics with a higher gradient, that is to say a larger gain factor between the installation voltage difference and the reactive current.

It has additionally been recognized here that, in the event of a grid fault, communication paths within the wind farm, in one example, between individual wind power installations and a central farm controller, may also be impacted. For this purpose, it is possible to use the fixedly specified voltage setpoint, which may be stored in each wind power installation. This is the alternative method, or part of the alternative method. It is thus in one example proposed, in this event of a grid fault, for the wind power installations to basically operate independently and/or autonomously.

In one example, it is proposed, for the wind power installations that switch to the simplified alternative method, for the determination of an individual installation voltage setpoint to be frozen until the grid fault has finished and/or until the wind power installations have left the simplified alternative method again.

In one example, provision is made, when using a controller having an integral component, for the integral component to be frozen. Provision may be made for such freezing for a controller that is used in each case to calculate an individual control correction value or voltage correction value. It may contain a PI controller or be a PI controller, and it has been found to be advantageous therefor, in the event of a grid fault when this controller is then no longer being used, for its integral component to be frozen. It therefore retains its output values and ignores its input values for this frozen period. As soon as the grid fault has passed, the controller may continue its work in the same way as before the grid fault in order to determine the individual control correction value or voltage correction value.

The duration of the grid fault may be taken into consideration as a criterion for how long freezing is carried out or, as an alternative or in addition, whether the wind power installation has left the simplified method again. This is often also an indicator of the end of the grid fault. If both criteria are considered at the same time, the freezing should be ended if both criteria are met.

According to one aspect, it is proposed, in the event of a grid fault occurring (e.g., in an FRT, LVRT or OVRT case), if the determination of the individual installation power at one or some but not at all wind power installations is changed to a simplified alternative method, for the determination of the individual installation control setpoints, in one example, installation voltage setpoints, to be continued for the other wind power installations, that is to say to be continued for the wind power installations that have not been switched to the simplified alternative method.

For this purpose, it is proposed, in order to determine the individual installation control setpoints or installation voltage setpoints, to use a sum of all reactive powers that are fed in from only those wind power installations that have not been changed to the simplified alternative method. It is thus proposed here for the balancing to be continued at the remaining wind power installations if only some of the wind power installations are affected by the grid fault event.

According to one aspect, it is proposed for a correction controller used to determine the individual control correction value, in one example, voltage correction value from the average difference in the form of a difference between the respective individual installation reactive power and an average of all individual installation reactive powers, to be parameterized in each case such that it is similarly fast or faster than a farm controller used to determine the farm control setpoint, in one example, farm voltage setpoint, and/or for the correction controller to have a control time constant that is at most twice as great as a control time constant of the farm controller, in one example, is less than a control time constant of the farm controller.

Aspects of the present disclosure have been developed recognizing that the control correction value or voltage correction value is able to be determined via a correction controller. The correction controller may be designed in one example, as a PI controller. It thereby has dynamics that should as far as possible not conflict with the dynamics of the farm controller that determines the farm control setpoint or farm voltage setpoint, namely from the farm reactive power setpoint and a or the farm reactive power actual value. Such a farm controller may likewise be a PI controller in order to achieve steady-state accuracy for the farm reactive power, in order thus to bring the farm reactive power actual value to the farm power setpoint.

In order to avoid such a conflict between the two dynamics of the two controllers, it has been recognized that the correction controller should not be significantly slower than the farm controller. It is therefore proposed to select the correction controller to be correspondingly fast, and this may be carried out by defining the control time constant. The smaller this is, the faster the corresponding controller.

It has been recognized that it should be slightly slower than the farm controller, so that double the control time constant would still be permissible. However, the control time constant of the correction controller may be be selected to be smaller than the control time constant of the farm controller. For this purpose, it has also been recognized that an overall structure results in which the correction controller, with respect to the farm controller, may form an inner cascade that has faster control dynamics than the outer cascade.

According to the present disclosure, what is also proposed is a wind farm. The wind farm is prepared to provide a farm reactive power by way of multiple wind power installations of the wind farm, where the wind farm has a controller that is prepared to carry out a method having the following steps:
receiving a farm target setpoint, which characterizes or influences a farm reactive power, used to specify a farm reactive power to be fed in by the wind farm,
determining a farm control setpoint as a common target value for all wind power installations as a function of the farm target value,
determining an individual installation control setpoint in each case for one of the wind power installations as a function of the farm control setpoint,
determining and outputting an individual installation reactive power in each case by way of one of the wind power installations as a function of an installation voltage difference in the form of a difference between an installation actual voltage and an individual installation voltage setpoint of the respective wind power installation, where the individual installation voltage setpoint is determined from the individual installation control setpoint of the respective wind power installation, or corresponds to the individual installation control setpoint, and where
the individual installation control setpoint is determined in each case as a function of the individual installation reactive power of the respective wind power installation and as a function of multiple, in one example, all individual installation reactive powers of the wind power installations of the wind farm.

The wind farm may in one example, be prepared to carry out the method by virtue of provision being made for appropriate control units on which the method is implemented. Provision is made in one example, for a central farm controller for receiving the farm target value such as farm reactive power setpoint and for determining the farm control setpoint, in particular farm voltage setpoint. An individual installation control value, in one example, installation voltage setpoint, and an individual installation reactive power may each be determined in an installation controller of the respective wind power installation.

The corresponding method steps for this are each implemented in such an installation controller. Provision may be made to consider some, several or all individual installation reactive powers of the wind power installations of the wind farm using the central farm controller. The central farm controller may in one example, average all installation reactive powers of the wind power installations of the wind farm. Such an average may then be transmitted from the central farm controller to the individual installation controllers for further use. The central farm controller may have interfaces for receiving installation reactive power actual values in order to determine the average of all installation reactive powers from these installation reactive power actual values.

However, it may also be considered for even the individual installation control values, in one example, installation voltage setpoints, to be calculated in the central farm controller and transferred to the individual wind power installations. Each wind power installation may work on its own to determine the respective installation reactive power and use the individual installation voltage setpoint and an installation actual voltage measured at the respective wind power installation to do so.

The controller of the wind farm should thus be understood in one example, to be a distributed control unit, and the controller of the wind farm may also be referred to synonymously as a control unit. This control unit is formed in one example, by the central farm controller and multiple installation controllers, where the installation controllers are each arranged on a wind power installation and are connected to the central farm controller via a communication connection. It is in one example, proposed for the central farm controller and the installation controllers to be connected to one another via a bus system for communication purposes.

According to one aspect, it is proposed for the wind farm to include the central farm control unit and multiple installation controllers, where in each case one of the installation controllers is arranged on a respective wind power installation, the installation controllers are connected to the farm control unit via a communication system, in one example, via a data bus system, and a method for providing the farm reactive power is implemented on the central farm control unit and the multiple installation controllers.

It has been recognized here that the method for providing the farm reactive power should be carried out partly at a central location and partly at the installations, and so it is proposed to use the central farm control unit and the multiple installation controllers.

According to one aspect, it is proposed for the wind farm to be prepared to carry out a method according to one of the embodiments explained above and/or for a method according to one of the above embodiments to be implemented in the central farm control unit and the multiple installation controllers. A wind farm constructed in this way is thereby able to exploit the advantages of the method according to the aspects described.

### BRIEF DESCRIPTION OF THE SEVERAL VIEWS OF THE DRAWINGS

The present disclosure will now be explained in more detail below, by way of example, based on embodiments, with reference to the accompanying figures.

FIG. 1 shows a perspective and schematic view of a wind power installation.

FIG. 2 shows a schematic illustration of a wind farm.

FIG. 3 schematically shows a reactive power control process in a wind farm, illustrating only one wind power installation.

FIG. 4 illustrates the dynamics of a reactive power infeed based on a specified farm voltage using two timing diagrams.

FIG. 5 schematically shows a reactive power control process in a wind farm, similar to FIG. 3, but with two illustrated wind power installations as an example.

FIG. 6 shows an illustrative timing diagram for explaining problems that may occur due to a reactive power control process in accordance with the structure of FIG. 5.

FIG. 7 shows a further timing diagram for illustrating another problem that may occur due to the reactive power control process in accordance with the structure of FIG. 5.

FIG. 8 schematically shows a structure for carrying out reactive power control in a wind farm in order to balance the reactive power of the individual wind power installations.

FIG. 9 shows an extended structure compared to FIG. 8.

FIG. 10 schematically shows a structure for carrying out reactive power control in a wind farm in order to balance the reactive power of the individual wind power installations, similar to FIG. 9 but in another constellation.

FIG. 11 shows a structure similar to figure S with a further detail.

FIG. 12 shows a structure similar to FIG. 11 but with a modification.

FIG. 13 shows a structure similar to FIG. 9 with a further detail.

FIG. 14 shows an inner structure of a central farm controller.

### DETAILED DESCRIPTION

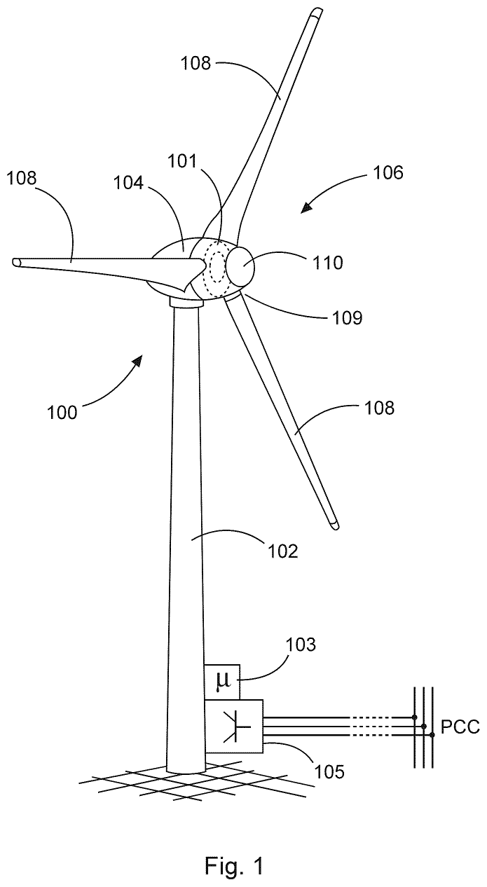

FIG. 1 shows a schematic illustration of a wind power installation according to the present disclosure. The wind power installation 100 has a tower 102 and a nacelle 104 on the tower 102. An aerodynamic rotor 106 with three rotor blades 108 and a spinner 110 is provided on the nacelle 104. During operation of the wind power installation, the aerodynamic rotor 106 is set in rotation by the wind and thus also turns an electrodynamic rotor of a generator, which is coupled directly or indirectly to the aerodynamic rotor 106. The electric generator is arranged in the nacelle 104 and generates electrical energy. The pitch angles of the rotor blades 108 are able to be changed by pitch motors at the rotor blade roots 109 of the respective rotor blades 108. The wind power installation 100 has an electric generator 101 here, which is indicated in the nacelle 104. The generator 101 may be used to generate electrical power. A feeding-in unit 105, which may be designed in one example, as an inverter, is provided for the purpose of feeding in electrical power. It is therefore possible to generate a three-phase infeed current and/or a three-phase infeed voltage, according to amplitude, frequency and phase, for feeding in at a grid connection point PCC. This may be done directly or together with other wind power installations in a wind farm. An installation controller 103 is provided for the purpose of controlling the wind power installation 100 and also the feeding-in unit 105. The installation controller 103 may also receive target values from external sources, in one example, from a central farm computer.

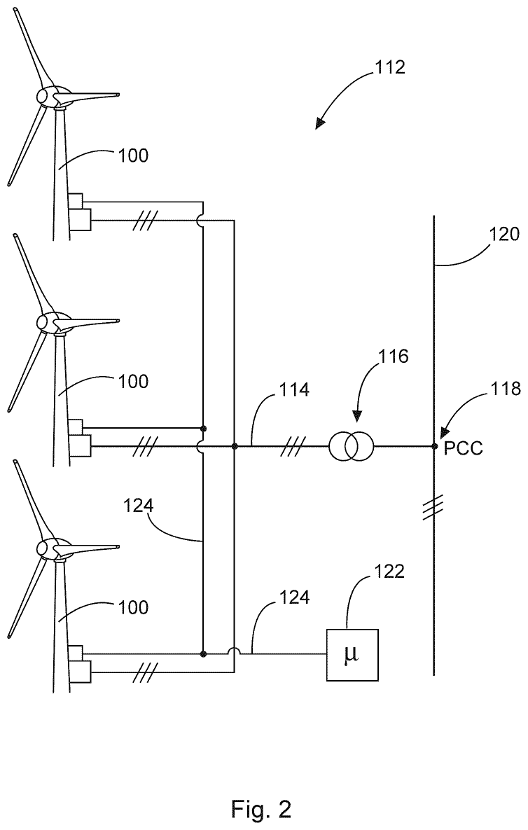

FIG. 2 shows a wind farm 112 having for example three wind power installations 100, which may be identical or different. The three wind power installations 100 thus in principle represent any desired number of wind power installations of a wind farm 112. The wind power installations 100 provide their power, in one example, the generated current, via a farm electricity grid 114. In this case, the respectively generated currents or powers from the individual wind power installations 100 are summed and there is usually provision for a transformer 116 that boosts the voltage in the farm in order then to feed it into the supply grid 120 at the feeding-in point 118, which is generally also referred to as PCC. FIG. 2 is only a simplified illustration of a wind farm 112. The farm grid 114 may for example be designed differently, for example in that a transformer is also present at the output of each wind power installation 100, to cite just one other exemplary embodiment.

The wind farm 112 also has a central farm computer 122, which may also be referred to synonymously as a central farm controller or central farm control unit. This may be connected to the wind power installations 100 via data lines 124, or wirelessly, in order to use same to exchange data with the wind power installations and in one example, to obtain measured values from the wind power installations 100 and to transmit control values to the wind power installations 100.

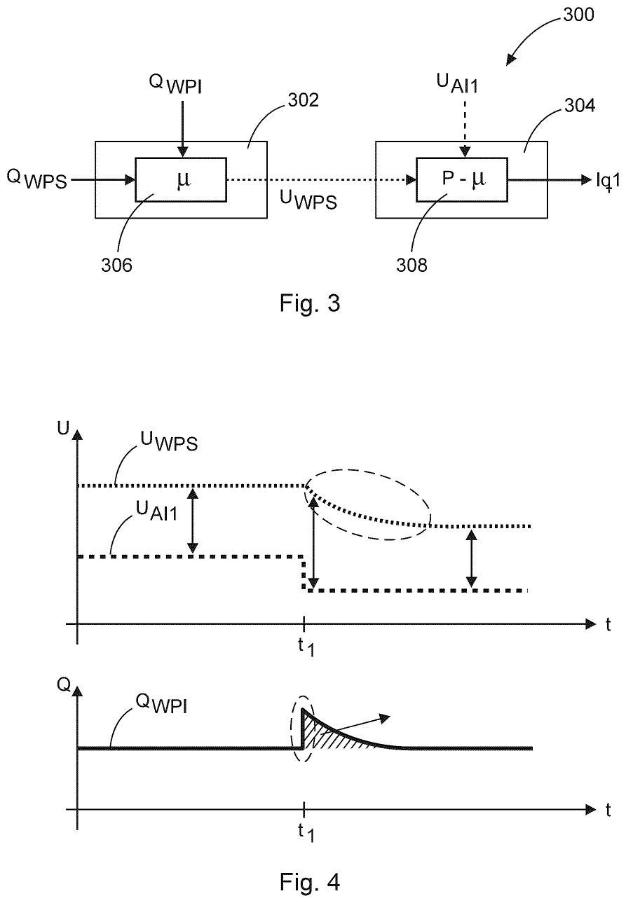

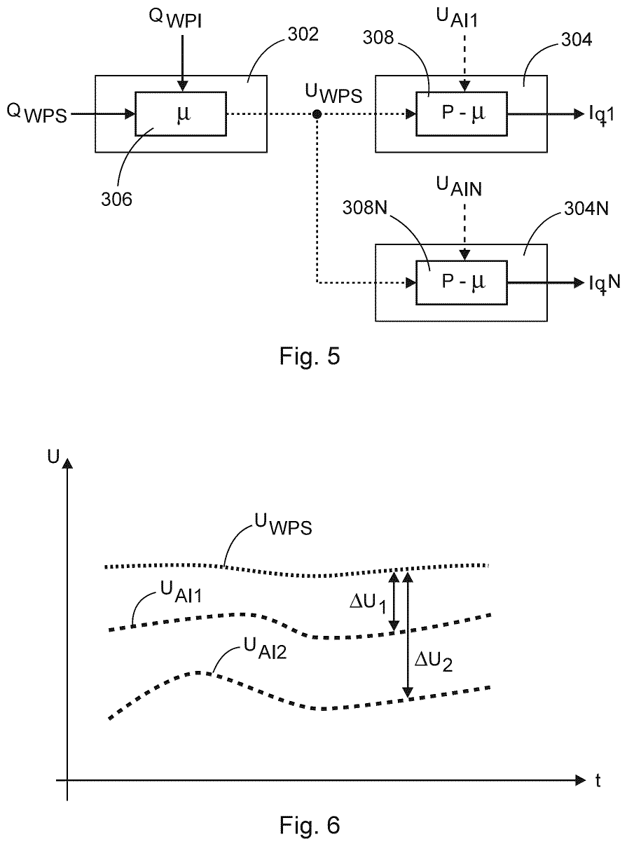

FIG. 3 schematically shows a control structure 300 of a wind farm, which is intended to illustrate in one example, an interaction between a central farm controller 302 and a wind power installation 304. In this respect, only one wind power installation 304 is illustrated for this illustration, multiple wind power installations of course being present in a wind farm. This is also discussed in connection with FIG. 5.

In any case, the central farm controller 302 is generally provided in order to control the wind farm, which includes various interactions including exchanging information with the individual wind power installations of the wind farm. Among other things, a farm reactive power controller 306 is contained in this central farm controller 302. This farm reactive power controller 306 receives a farm reactive power setpoint Q_{WPS}. This may also contain multiple setpoints, which are provided for example for different time windows.

The farm reactive power controller 306 for this purpose additionally receives the farm reactive power actual value Q_{WPI}. This may contain multiple values, in one example, in each case the current reactive power value that the wind farm outputs to the electrical supply grid.

The farm reactive power controller 306 determines a farm voltage setpoint U_{WPS} from the farm reactive power setpoint Q_{WPS} and the farm reactive power actual value Q_{WPI}. This farm voltage setpoint U_{WPS} may also be understood as a voltage setpoint for the wind power installations, as it specifies a setpoint for these wind power installations. However, since this farm voltage setpoint U_{WPS} is the same for all wind power installations and, in this regard, only one such value is currently available in each wind farm, it is referred to here as a farm voltage setpoint U_{WPS}.

The farm voltage setpoint U_{WPS} is then transferred to a respective installation reactive power controller 308 for implementation. This installation reactive power controller 308 may thus be part of the wind power installation 304. It may also in principle be part of an installation controller of the wind power installation 304.

In any case, in addition to the farm voltage setpoint U_{WPS}, the installation reactive power controller 308 also receives a value of an installation voltage U_{AI1}, where the index 1 indicates that this installation actual voltage belongs to the first wind power installation, which is shown namely in FIG. 3 as wind power installation 308. The installation reactive power controller 308 determines an installation reactive current I_{q1} as a function of these input values. The index 1 merely indicates that this installation reactive current belongs to the first installation, assuming that the wind power installation 308 illustrated in FIG. 3 is the first wind power installation or wind power installation 1.

A proportional controller is provided in one example, as the installation reactive power controller 308, such that the installation reactive current I_{q1} is calculated using the following formula, where K is a proportionality factor that may be specified as a controller gain:

$${I}_{q 1} = K ( {U}_{WPS} - {U}_{AI 1} )$$

A change in the installation actual voltage U_{AI1} therefore immediately affects the installation reactive current I_{q1}. A jump in the input variables therefore also leads to a jump in the installation reactive current I_{q1}. Since the installation reactive power controller 308 is designed as a P controller, it is not able to achieve steady-state accuracy.

However, steady-state accuracy may be achieved using the farm reactive power controller 306, because it may be designed as a PI controller. For this purpose, this PI controller may form a control error from the farm reactive power setpoint and the recorded farm reactive power actual value, and use this as a basis for determining a modified farm reactive power setpoint, which is thus determined such that the control error is adjusted as far as possible.

The idea here is for the wind farm itself to consume reactive power, such that, of the reactive power generated in the farm, less thereof is able to be provided at the grid connection point. The recorded farm reactive power then does not reach the specified farm reactive power; a control error occurs. The control error has the result, in the PI controller, that the modified farm reactive power setpoint increases until it is higher than the unmodified farm reactive power setpoint by a difference that corresponds to the reactive power consumed in the farm.

The PI controller may be limited as a function of a nominal power and/or maximum reactive power. It may in one example, be limited to a maximum reactive power of the wind farm. The limitation may be such that its I component is limited, or it may include same. This prevents the I component from being further integrated without limitation if the reactive power setpoint is not reached.

FIG. 4 illustrates, for the constellation according to FIG. 3, the dynamic behavior in the event of a voltage jump, which is negative here, in the installation actual voltage U_{AI1}. For this purpose, the upper diagram shows a temporal profile of the farm voltage setpoint U_{WPS} along with the profile of an installation actual voltage U_{AI1}. At the time t₁, a sudden drop in the installation actual voltage U_{AI1} is assumed. This may be triggered in one example, by a corresponding grid event, which is not discussed further here.

In any case, a reactive power diagram is illustrated for this upper voltage diagram. This reactive power diagram thus shows the farm reactive power actual value Q_{WPI}. It is assumed, for this farm reactive power actual value, that it is recorded at the output of the wind farm, and it is assumed, based on FIG. 3, that various other wind power installations such as the wind power installation 308 are present, all of which are controlled in the same way and also have a completely identical P controller for generating the installation reactive current.

In this case, the voltage dip of the installation actual voltage U_{AI1}, which is also assumed in this sense in the other wind power installations, leads to a jump in the installation reactive current and thus to a jump in all installation reactive currents, and thus to a jump in the farm reactive power, that is to say the farm reactive power actual value.

Only this sudden increase in the farm reactive power actual value, which is circled in dashed lines in the lower diagram, then leads to the farm reactive power controller 306 adapting the farm voltage setpoint U_{WPS} according to FIG. 3. Since the farm reactive power controller 306 may be designed as a PI controller for this purpose, this results in the illustrated slow dynamics with which the farm voltage setpoint drops, from the time t₁, with the illustrated dynamics, which are circled in dashed lines in the upper diagram. This takes place until the same voltage gap between the farm voltage setpoint U_{WPS} and the installation actual voltage U_{AI1} as before the voltage dip at t₁ arises again. In the meantime, the farm reactive power actual value Q_{WPI} has then also accordingly dropped back to the value before the event at the time t₁.

The farm reactive power may thus be adjusted to its setpoint.

FIG. 5 is based on the same scheme as FIG. 3, but has shown another wind power installation 308N to illustrate the distribution of the reactive power generation in the wind farm across the individual wind power installations. It is representative of the fact that N installations are present in the wind farm. In this respect, FIG. 5 only schematically shows the first and last wind power installation of the wind farm, as it were.

FIG. 5 thus shows a further wind power installation 304N having a further, associated installation reactive power controller 308N. Accordingly, for the wind power installation 304N, the installation reactive power controller 308N receives the installation voltage actual value U_{AIN} and determines the installation reactive current value I_{qN}. For the sake of simplicity, the same reference signs are used for FIG. 5 and FIG. 3, and the explanations for FIG. 3 also apply in this regard to FIG. 5.

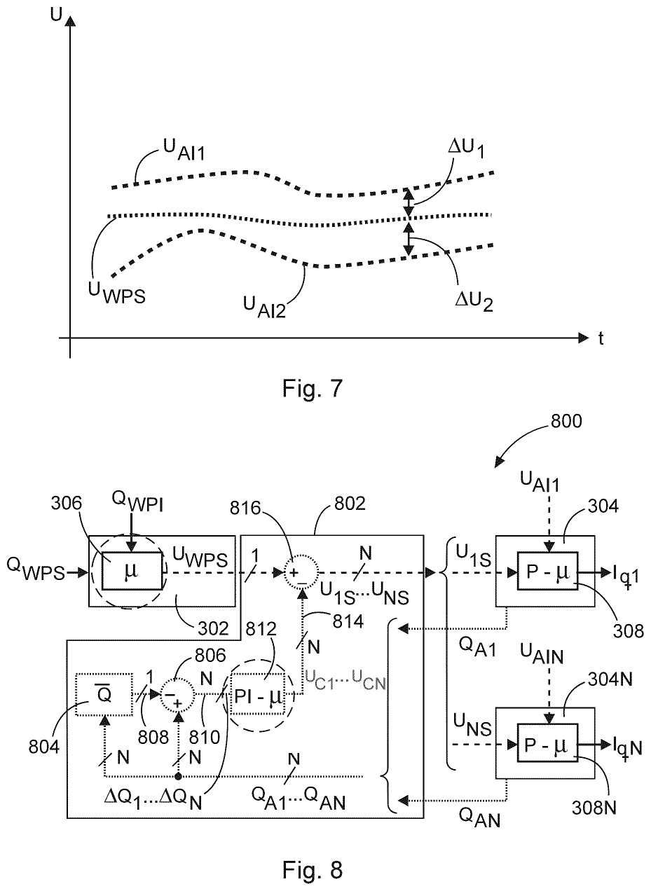

FIG. 5 is intended to illustrate in one example, that the wind power installations 308 and 308N receive the same farm voltage setpoint U_{WPS}. This may give rise to the following situations, which are explained in FIGS. 6 and 7.

FIG. 6 shows a timing diagram of a farm voltage setpoint U_{WPS} as is specified in the structures of FIGS. 3 and 5, together with the two installation actual voltages U_{AI1} and U_{AI2}. Both installation actual voltages U_{AI1} and U_{AI2} are the installation actual voltages of two representative wind power installations. In the simplest case, it may be assumed for illustration that this corresponds to the two wind power installations 304 and 304N of FIG. 5.

The diagram of FIG. 6 thus illustrates that different installation actual voltages U_{AI1} and U_{AI2} lead to different differential voltages ΔU₁ and ΔU₂ and thus, in the case of identically parameterized installation reactive power controllers, to correspondingly different reactive powers each to be generated by the wind power installation in question. This thus results in an unequal distribution of the reactive powers to be generated by the individual wind power installations.

The different voltage levels of the installation actual voltages U_{AI1} and U_{AI1} mentioned by way of example may in this case for example be caused by different line impedances between the wind power installation in question and a common grid connection point of the wind farm. The different line impedances may result from different distances between the respective wind power installations and this common grid connection point.

FIG. 7 basically shows the same diagram as FIG. 6, and so the same designations are also used. The diagram of FIG. 7 illustrates a case in which the farm voltage setpoint U_{WPS} lies between the two installation actual voltages U_{AI1} and U_{AI2}. In the case of a control process according to FIG. 5, this then leads to a negative voltage difference at one wind power installation and a positive voltage difference at the other one, ΔU₁ and ΔU₂, respectively, such that one wind power installation—in simple terms—contributes negative reactive power and the other contributes positive reactive power, that is to say a capacitive reactive power and an inductive reactive power. The two wind power installations thus work against one another, as it were.

It would be more efficient in this exemplary simplified case if both wind power installations were to generate (almost) no reactive power at all in the situation shown, instead of both wind power installations generating reactive power of the same or a similar level only with different mathematical signs. The proposed solution of adapting the installation voltage setpoint, in one example, using the voltage correction value, makes it possible to avoid such a situation, or at least reduce it. This also applies to the situation described in FIG. 6.

FIG. 8 schematically shows a farm reactive power controller 800 having a proposed control structure for distributing the individual installation reactive powers, in one example, equalizing or balancing them.

One advantage of the solution shown in FIG. 8 is that of supplementing a modification control structure 802 that is otherwise based on known structures and controllers.

In one example, it is possible to continue using a central farm controller 302 with a farm reactive power controller 306 in unchanged form, as illustrated in FIGS. 3 and 5. The same reference signs are accordingly used here, even though differences may be present. The wind power installations 304 and 304N with the installation reactive power controller 308 and 308N, respectively, may also correspond to those of FIGS. 3 and 5. In this respect, the same reference signs as in FIG. 3 and FIG. 5, respectively, are also used for the wind power installations 304 and 304N, even if differences should be present.

One difference is illustrated here in FIG. 8, according to which each wind power installation 304 or 304N outputs an installation reactive power Q_{A1} or Q_{AN}, respectively, as a signal for use in the modification control structure 802. The two installation reactive powers Q_{A1} and Q_{AN} are, in this respect, only representative of N, that is to say multiple installation reactive powers of N, that is to say multiple wind power installations. In other words, only the first and the Nth wind power installation are shown for illustration.

These N installation reactive powers Q_{A1} to Q_{AN} are then transferred to the modification control structure 802 and are then combined in an N-dashed signal path. All signal paths marked with N are therefore representative of N individual signal paths. Corresponding controllers or other functional elements that interact with such an N signal path may also be considered to be N elements.

In any case, provision is made for an average of these N installation reactive powers Q_{A1} to Q_{AN} to be calculated in the averaging block 804 and transferred to the first summing point 806.

At the first summing point 806, a difference is calculated for each of the N installation reactive powers Q_{A1} to Q_{AN}, in which the generated reactive power average 808 is subtracted in each case from each installation reactive power Q_{A1} to Q_{AN}. In this respect, the first summing point 806 actually represents N individual summing points. In any case, the result is an average difference ΔQ₁ to ΔQ_{N}. These N reactive power average differences are thus combined in the average difference path 810 and are transferred to a voltage correction controller 812. The voltage correction controller 812 therefore also represents N controllers, because each of the N average differences that are supplied via the average difference path 810 are each supplied to a single controller. Nevertheless, these N controllers of the voltage correction controller 812 are identical in terms of design and parameterization.

Each controller of the voltage correction controller 812 is designed here as a PI controller, which may have a limitation on the integral portion.

The result of the voltage correction controller 812 is N voltage correction values U_{C1} to U_{CN}. These N voltage correction values are transferred to the second summing point 816 via the voltage correction path 814.

The second summing point 816 likewise consists of N individual summing points. At each summing point, a respective one of the voltage correction values U_{C1} to U_{CN} is subtracted in each case from the farm voltage setpoint U_{WPS}. The result is thus N individual installation voltage setpoints U_{1S} to U_{NS}, which are then accordingly each transferred to the wind power installations 304 to 304N or the installation reactive power controllers 308 to 308N.

Each wind power installation thereby receives its individual installation voltage setpoint. The individual wind power installations may thereby be operated as previously and, as previously, determine a reactive current as a function of an installation voltage setpoint. Only the installation voltage setpoint, which was previously identical for all wind power installations, has been individualized. This has been achieved by distributing the installation voltage setpoint U_{WPS} into individual installation voltage setpoints using the modification control structure 802.

The distribution is carried out such that the amount of reactive power generated by each individual wind power installation is taken into consideration in each case. This value is compared to the reactive power average of all installation reactive powers at the first summing point 806 and, in simplified terms, the difference from the reactive power average is adjusted in each case. For this purpose, the first summing point determines a control deviation of the respective installation reactive power for each wind power installation, as it were, because the reactive power average may also be understood, in illustrative terms, to be a reactive power setpoint for each wind power installation.

The adjustment is carried out by the voltage correction controller 812, which outputs a voltage correction value U_{C1} to U_{CN}, which may basically be understood to be a manipulated variable, for each wind power installation.

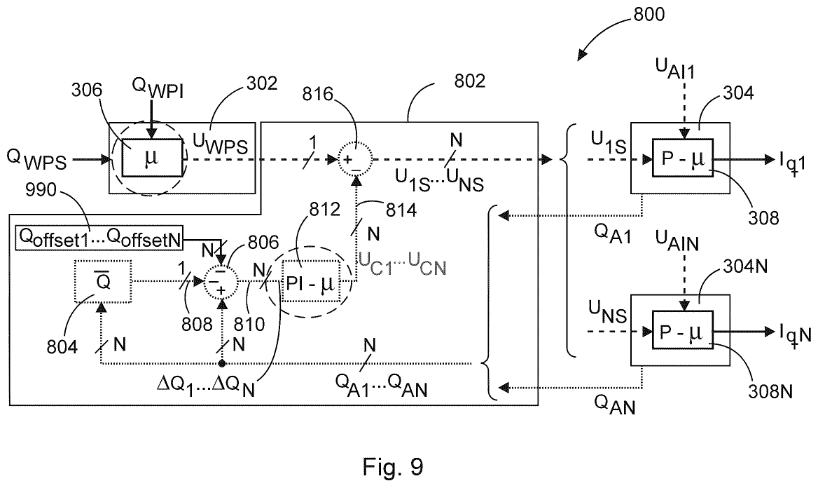

FIG. 9 schematically shows a farm reactive power controller 800 having a proposed control structure for distributing the individual installation reactive powers, in one example, equalizing or balancing them. The figure is similar to FIG. 8, and therefore, for the sake of clarity, the same reference signs from FIG. 8 are also adopted in FIG. 9.

Essentially, an installation offset block 990 has been added to the farm reactive power controller 800, this being able to subtract installation offsets Q_{offset1} to Q_{offsetN} at the first summing point 806. As a result, individual installation offsets are each subtracted from the corresponding average difference ΔQ₁ to ΔQ_{N}, or lead to correspondingly changed average differences ΔQ₁ to ΔQ_{N}.

It is therefore proposed to influence the distribution of the farm reactive power setpoints between the wind power installations for further optimization purposes by summing a set of offset values, that is to say individual installation offsets Q_{offset1} to Q_{offsetN}, as illustrated in FIG. 9 by the installation offset block 990.

In one example, the following scenarios may be solved with the proposed solution, possibly with a further modification.

According to one scenario, mixed farms, that is to say wind farms containing different wind power installation types and/or wind farms containing restricted wind power installations, are considered. These are thus wind power installations that generate less power, in one example, temporarily, than they could, for example because they are each in the wake of another wind power installation.

The following problem arises for such wind farms.

If the values, reported back to the modification control structure (802 according to FIG. 8), of the actual reactive power, that is to say of the installation reactive power or installation actual reactive power Q_{A1} . . . . Q_{AN} are used in absolute physical units (var or in Mvar) according to FIG. 8, this gives rise to identical reactive powers (in var or in Mvar) for all wind power installations. This situation is not optimum in mixed farms containing different wind power installation types, since the wind power installations may have different nominal reactive powers. Identical absolute reactive powers (in var or Mvar) for all wind power installations may for example result in one wind power installation reaching its nominal reactive power while another wind power installation having a greater reactive power has not yet reached its nominal reactive power and is therefore not yet operating at full load.

The following solution is proposed:

The reported-back values of the actual reactive power, that is to say of the installation reactive power or installation actual reactive power Q_{A1} . . . . Q_{AN}, will be reported back as a percentage of the nominal reactive power of the respective wind power installation. As an alternative, this conversion may take place in the farm control unit, also referred to as FCU. In the illustrated structure (FIG. 8), this thus results in identical reactive powers in terms of percentage of the nominal reactive power for all wind power installations.

A note concerning wind farms, which may also be referred to for simplicity and synonymously as farms, containing restricted wind power installations:

The situation mentioned above with regard to mixed farms may also occur in farms containing a uniform type of wind power installation, if one or some of the wind power installations are permitted to operate on a restricted basis for a technical reason or some other reason. One example of this is when a power cabinet in a wind power installation is defective and the corresponding wind power installation is able to continue to operate with a restricted active and reactive power range following deactivation of the affected power cabinet. In this case too, identical absolute reactive powers (in var or in Mvar) are not expedient for all wind power installations. In order to solve this problem, the reported-back values of the actual reactive power, that is to say of the installation reactive power or installation actual reactive power Q_{A1} . . . . Q_{AN}, should be converted into a percentage of the maximum available reactive power of the respective wind power installation.

According to a further scenario, a limitation of the reactive power differences to be balanced is considered.

The following problem arises in this regard:

If a limitation for the balancing of the wind power installation reactive powers is desired, the outputs of the voltage correction controller 812 (see FIG. 8) should be limited. The simplest option would be to use a limiter function (±ΔQₗᵢₘᵢₜ) for the outputs of the voltage correction controller 812. However, in many cases, this could lead to the average of the outputs of the voltage correction controller 812 no longer corresponding to the value zero. It should be noted that the average of the outputs of the voltage correction controller 812 should correspond to the value zero at all times. Otherwise, the uniform setpoint U_{WPS} would be distorted by the balancing of the wind power installation reactive powers.

The following is proposed as a solution.

As one possible solution to the abovementioned problem, the following modification is proposed at the outputs of the voltage correction controller 812, this having already been mentioned above and being reproduced here in other words by the following steps.

1) Ascertain the respective absolute value for the outputs of the voltage correction controller 812, that is to say the absolute value for the respective voltage value that is output at the output. In the case of N wind power installations, this results in N absolute values.

2) The largest of these absolute values, that is to say the N absolute values, is selected. This may be considered to be the greatest voltage correction value in terms of absolute value. An associated reactive power value ΔQₘₐₓ is assigned to this greatest absolute value, which is a voltage value. This value ΔQₘₐₓ denotes the differential reactive power that would result from the greatest voltage correction value if it were passed on to the corresponding proportional controller of the corresponding wind power installation.

3) Compare ΔQₘₐₓ with ΔQₗᵢₘᵢₜ, where ΔQₗᵢₘᵢₜ denotes the maximum reactive power deviation provided as a limitation.

4) (a) If ΔQₘₐₓ is less than or equal to ΔQₗᵢₘᵢₜ, then pass on the outputs of the reactive power controller 308 without modification.

5) (b) If ΔQₘₐₓ is greater than ΔQₗᵢₘᵢₜ, then multiply all outputs of the reactive power controller 308 by a factor of ΔQₗᵢₘᵢₜ/ΔQₘₐₓ and pass on the results.

The abovementioned modification limits the outputs of the reactive power controller 308, which may be referred to as reactive power differences to be balanced, to a maximum value of ΔQₗᵢₘᵢₜ, while their average corresponds to the value zero at all times.

According to one scenario, possible problems regarding coordination between wind power installations and a central farm controller during an FRT fault are considered.

The following problem arises:

If the voltage drops below a predefined limit at the grid connection point of a wind power installation due to a short circuit in the grid (inside or outside the wind farm), the wind power installation switches its operating mode and changes from the normal operating mode to FRT mode, which may also be referred to synonymously as an alternative method or simplified alternative method.

Different behavioral strategies, hereinafter referred to as fault strategies, are prescribed in different countries for this FRT mode or the alternative method. In most fault strategies, the external setpoint, that is to say the specified reactive power setpoint and thus the resulting farm voltage setpoint of the central farm controller, should no longer be tracked. Instead, reactive currents should be fed in as a function of the actual voltage using a predefined equation.

Since the setpoint of the FCU is no longer able to be tracked in FRT mode, there is a risk in such a case of the superordinate farm reactive power controller, which may also be referred to as FCU controller, regulating against this conceptual deviation. This results in conflicting control effects at the FCU and wind power installation level that are not expedient. The situation becomes slightly more complicated when the voltage dip is located close to the predefined limit for activating FRT mode. Due to small differences between the voltage at the grid connection point and the voltage at the respective wind power installation, some of the wind power installations may go into FRT mode while the other wind power installations are in normal operation. In such a case, the FCU should be able to operate the two groups of wind power installations (those in normal operating mode and those in FRT mode).

The following solution is proposed in this regard:

The following is proposed as a solution to the abovementioned problem: As soon as a wind power installation is in FRT mode, the mode change is reported back to the FCU. Two cases are then possible based on the depth of the voltage dip:

Case 1) The voltage dip is so deep that the voltage at all wind power installations falls below the limit value for entering FRT mode. All wind power installations controlled by the FCU thus go into FRT mode and usually provide a certain reactive current independently of the FCU reactive power setpoint, said reactive current being determined by the activated fault strategy. The FCU receives the information that all wind power installations are in FRT mode. In order to avoid conflicting control effects at the FCU and wind power installation level, it would be possible to freeze the U setpoint and any integral controller values in the FCU as a result of this information feedback and to reactivate them only after all wind power installations have returned to normal operating mode.

Case 2) The voltage dip is so deep that the voltage at one or more wind power installations falls below the limit value for entering FRT mode, while it remains above this limit value at at least one wind power installation. In this case, the following procedures are proposed as alternatives:

Variant 1: The U setpoint and any integral controller values in the FCU should be frozen, similarly to in case 1). As a result, no setpoint change is possible during the FRT fault, even though the wind power installations could contribute to implementing this setpoint in normal operation.

Variant 2: In this variant, the wind power installations that are not in FRT mode will make it possible to implement a setpoint change to a limited extent. This may be achieved as follows:

The reported-back actual reactive power of the wind power installations in FRT mode is subtracted from the measured actual reactive power, which is recorded in one example, at the grid connection point of the wind farm. The actual reactive power at the grid connection point of the wind farm, which is present at the input for the FCU controller or is input there, is thus “adjusted” for the reactive power of the wind power installations that are not able to be controlled due to the FRT mode, and the sum of the uncontrollable reactive powers is thus subtracted.

On the other hand, the reactive power setpoint that is present at the input for the FCU controller or is input there is multiplied by the following factor ko:

$${k}_{Q} = ( {Q}_{nennWP} - {Q}_{nennFRT} ) / {Q}_{nennWP}$$

where
Q_{nennWP}: nominal reactive power of the wind farm
Q_{nennFRT}: reactive power component of the wind power installations in FRT mode in relation to the nominal reactive power of the wind farm

The reactive power setpoint is thus adapted to the proportion of wind power installations that are in normal operating mode.

The FCU controllers are then able to control the wind power installations that are in normal operating mode with the “adjusted” setpoints and actual values, while the other wind power installations are in FRT mode.

Note: Variant 2 has been explained above by way of example for a Q controller at the FCU level. However, it may be applied with similar considerations to other FCU controller types, for example a phi controller, which specifies a phase angle as a function of a voltage deviation.

FIGS. 3 to 9 have explained parts of the present disclosure based on a constellation in which a farm target is specified as a farm reactive power setpoint, in which a farm control setpoint is determined as a farm voltage setpoint, and in which the individual installation control values are determined as individual installation control setpoints.

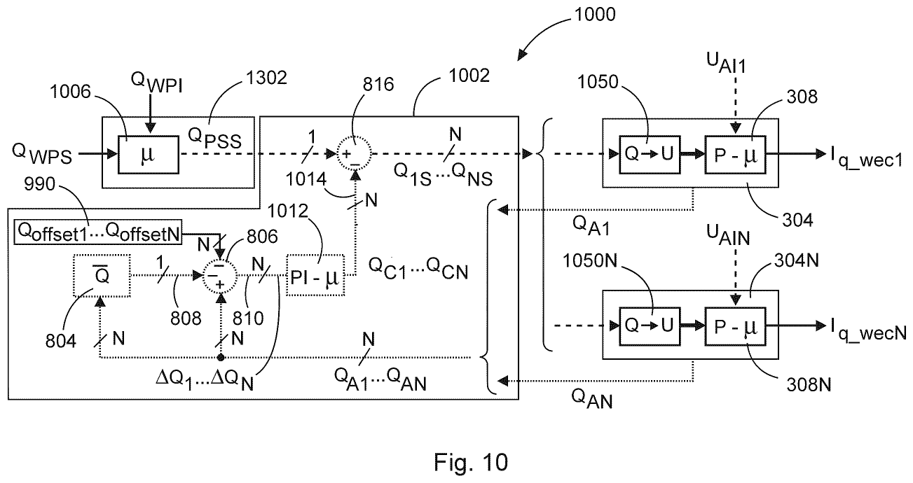

In the following FIG. 10, parts of the present disclosure are explained based on a constellation in which the farm target value is specified as a farm reactive power setpoint, the farm control setpoint is determined as a farm reactive power control setpoint used to specify a reactive power as a common target value for all wind power installations, and the individual installation control setpoints are determined as installation reactive power setpoints.

This constellation makes provision in one example, for the individual installation control values to be determined at the reactive power level. In other words, the farm control setpoint is a reactive power that is then modified into the individual installation control values, which for their part are also reactive power values. Only thereafter is reactive power converted into voltage, in one example, in each wind power installation. The individual installation voltage setpoints are thus determined for the first time in this step. The determination of the installation reactive powers or installation reactive currents based on the individual installation voltage setpoints may then be the same in both constellations.

FIG. 10 schematically shows a farm reactive power controller 1000 having a proposed control structure for distributing the individual installation reactive powers, in one example, equalizing or balancing them.

One advantage of the solution shown in FIG. 10 is that of providing a modification control structure 1002 that is otherwise based on known structures and controllers and is very similar to the modification control structure 802 of FIG. 8.

A central farm controller 1302 having a farm reactive power controller 1006 may in one example, continue to be used in substantially unchanged form, as illustrated in FIGS. 3 and 5, where, as a difference here, the central farm controller 1302 having the farm reactive power controller 1006 outputs a farm reactive power control setpoint Q_{PSS} as a farm control value. The farm reactive power control setpoint Q_{PSS} is thus a reactive power and is initially provided as a reactive power setpoint for all wind power installations. It is therefore smaller, in terms of size, than the farm reactive power setpoint Q_{WPS}, and may for example be 1/10 thereof if the wind farm contains 10 wind power installations.

However, it is also possible to specify the farm reactive power setpoint as a percentage. If for example 50% of the nominal reactive power of the wind farm is to be fed in, then the farm reactive power setpoint may be 50%, and the farm reactive power control setpoint, which is basically provided for the individual installations, may then also be 50%. However, for the farm reactive power control setpoint, the percentage should be understood as being relative to the nominal reactive power of each individual wind power installation. In the example, 50% as a farm reactive power control setpoint would mean that initially, that is to say before the proposed determination of the individual installation control setpoints (e.g., of the individual installation reactive power setpoints), takes place, all installations feed in 50% of their nominal reactive power. This may then lead to different absolute values at the wind power installations if the wind power installations have different nominal reactive powers. A nominal active power may also be taken as a reference instead of the nominal reactive power, both for the farm and for the individual wind power installations.

Otherwise, even though differences may be present, the same reference signs as in previous figures are used in part here. The wind power installations 304 and 304N with the installation reactive power controller 308 and 308N, respectively, may in one example, correspond to those of FIGS. 3 and 5. In this respect, the same reference signs as in FIG. 3 and FIG. 5, respectively, are also used for the wind power installations 304 and 304N, even if differences should be present.

One difference is illustrated here in FIG. 10, according to which the wind power installations 308 to 308N do not receive the N individual installation voltage setpoints U_{1S} to U_{NS} as an input variable, but rather determine them from the respective installation reactive power setpoint Q_{1S} to Q_{NS}, namely using the Q-U transform block 1050, which is representative of the control value transform function, or in which the control value transform function may be implemented.

A further difference here in FIG. 10 compared to FIGS. 3 and 5 is that each wind power installation 304 or 304N outputs an installation reactive power Q_{A1} or Q_{AN}, respectively, as a signal for use in the modification control structure 1002. The two installation reactive powers Q_{A1} and Q_{AN} are, in this respect, only representative of N, that is to say multiple installation reactive powers of N, that is to say multiple wind power installations. In other words, only the first and the Nth wind power installation are shown for illustration.

These N installation reactive powers Qui to Q_{AN} are then transferred to the modification control structure 1002, which may correspond to the modification control structure 802 of FIG. 8, and so the same reference sign is used. The N installation reactive powers Q_{A1} to Q_{AN} are then combined in an N-dashed signal path. All signal paths marked with N are therefore representative of N individual signal paths here as well. Corresponding controllers or other functional elements that interact with such an N signal path may also be considered to be N elements.

In any case, provision is made for an average of these N installation reactive powers Q_{A1} to Q_{AN} to be calculated in the averaging block 804, which may correspond to the one in FIG. 8, and transferred to the first summing point 806, which may also correspond to the one in FIG. 8.

At the first summing point 806, a difference is calculated for each of the N installation reactive powers Q_{A1} to Q_{AN}, in which the generated reactive power average 808 is subtracted in each case from each installation reactive power Q_{A1} to Q_{AN}. In this respect, the first summing point 806 actually represents N individual summing points. In any case, the result is an average difference ΔQ₁ to ΔQ_{N}, as also in FIG. 8. These N reactive power average differences are thus combined in the average difference path 810, likewise as in FIG. 8, and are transferred to a reactive power correction controller 1012. The reactive power correction controller basically corresponds to the voltage correction controller 812 of FIG. 8, but outputs a reactive power value in each case. The reactive power correction controller 1012 is therefore also representative of N controllers combined therein, because each of the N average differences that are supplied via the average difference path 810 are each supplied to a single controller. Nevertheless, these N controllers of the reactive power correction controller 1012 are identical in terms of design and parameterization; only their input and output values may differ.

Each controller of the reactive power correction controller 1012 is designed here as a PI controller, which may have a limitation on the integral portion.

The result of the voltage correction controller 812 of FIG. 8 is N voltage correction values U_{C1} to U_{CN}. The result of the reactive power correction controller 1012 of FIG. 10 described here is N reactive power correction values Q_{CI} to Q_{CN}. These N reactive power correction values are transferred, via the reactive power correction path 1014, to the second summing point 816, which, although it is applied to calculating reactive powers, otherwise corresponds to the summing point 816 in FIG. 8, and the reference sign has therefore been retained.

The second summing point 816 likewise consists of N individual summing points. At each summing point, a respective one of the N reactive power correction values Q_{C1} to Q_{CN} is subtracted in each case from the farm reactive power control setpoint Q_{PSS}. The result is thus N individual installation reactive power setpoints Q_{1S} to Q_{NS}, which are then accordingly each transferred to the wind power installations 304 to 304N or the installation reactive power controllers 308 to 308N.

The installation reactive power setpoints Q_{1S} to Q_{NS} are then each converted to an individual installation voltage setpoint, namely by the Q-U transform block 1050 or 1050N. Each wind power installation thereby receives its individual installation voltage setpoint. The individual wind power installations may thereby be operated as previously and, as previously, determine a reactive current as a function of an installation voltage setpoint. Only the installation voltage setpoint, which was previously identical for all wind power installations, has been individualized. This was achieved by using the modification control structure 1002 to distribute the farm reactive power control setpoint Q_{PSS} into individual installation reactive power setpoints Q_{1S} to Q_{NS}, which were finally converted to the installation voltage setpoints.

The distribution is carried out such that the amount of reactive power generated by each individual wind power installation is taken into consideration in each case. This value is compared to the reactive power average of all installation reactive powers at the first summing point 806 and, in simplified terms, the difference from the reactive power average is adjusted in each case. For this purpose, the first summing point determines a control deviation of the respective installation reactive power for each wind power installation, as it were, because the reactive power average may also be understood, in illustrative terms, to be a reactive power setpoint for each wind power installation.

The adjustment is carried out by the reactive power correction controller 1012, which outputs a reactive power correction value Q_{C1} to Q_{CN}, which may basically be understood to be a manipulated variable, for each wind power installation.

FIG. 10 additionally shows, in the farm reactive power controller 1000, an installation offset block 990 that is able to subtract installation offsets Q_{offset1} to Q_{offsetN} at the first summing point 806. The reference sign from FIG. 9 is retained here, because the installation offset block 990 may correspond to the one in FIG. 9, which has been added namely from FIG. 8 to FIG. 9. In this case too, individual installation offsets may be subtracted in each case from the corresponding average difference ΔQ₁ to ΔQ_{N} by the installation offset block 990, or the application of the installation offset block 990 results in correspondingly changed average differences ΔQ₁ to ΔQ_{N}.

It is therefore proposed to influence the distribution of the farm reactive power setpoints between the wind power installations for further optimization purposes by summing a set of offset values, that is to say individual installation offsets Q_{offset} to Q_{offsetN}, as illustrated in FIGS. 9 and 10 by the installation offset block 990.

In one example, the proposed solution makes it possible, possibly with a further modification, to solve the scenarios that have been explained above according to the description of FIG. 9 and that are also applicable for the constellation according to FIG. 10.

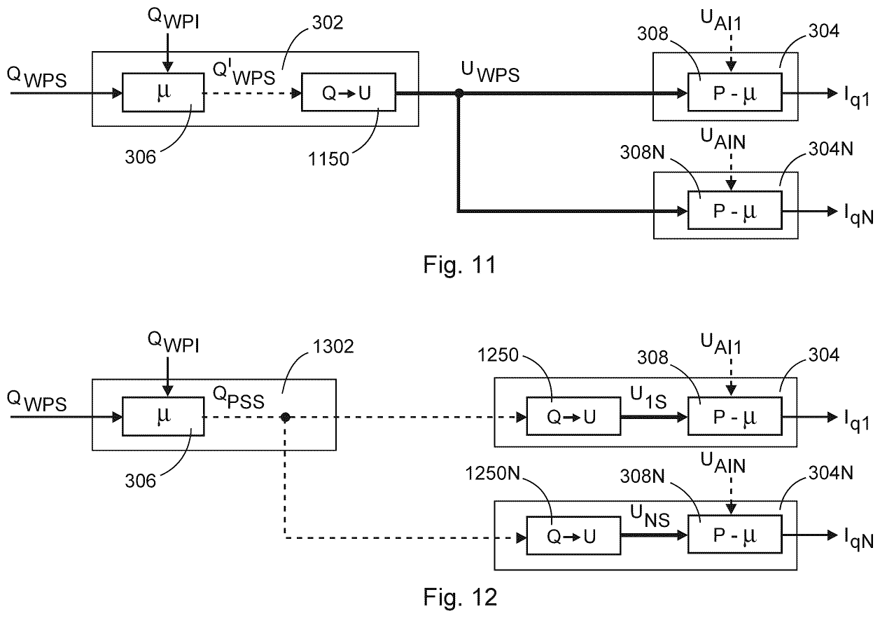

FIG. 11 shows a further aspect, but is based on FIG. 5, from which it basically differs only in terms of a Q-U transform block 1150, which describes a functionality that is contained in the central farm controller 302 according to FIG. 3. Therefore, the reference sign 302 is likewise used for the central farm controller in FIG. 11, as these two central farm controllers may be identical. In the Q-U transform block, the farm reactive power setpoint Q′_{WPS} is transformed into the farm voltage setpoint U_{WPS}, namely at the farm level.

The farm voltage setpoint U_{WPS} may be calculated in the Q-U transform block 1150 according to the following formula:

$${U}_{WPS} = {Q}_{WPS}^{′} / k + 100 \%$$

Here, k is a scaling factor that should be chosen, in one example, such that Q′_{WPS}/k is significantly less than 100% in terms of absolute value, because U_{WPS} should be close to 100%, because this means that the non-percentage value of U_{WPS} fluctuates around the nominal voltage by realistic values, k should be selected accordingly.

FIG. 12 shows a similar structure to FIG. 11, but with the difference that a transformation from a reactive power setpoint to a voltage setpoint takes place for the first time at the installation level, namely using a Q-U transform block 1250 or 1250N that is arranged in a respective wind power installation 304 or 304N, respectively. The Q-U transform block 1250 or 1250N in each case generates an individual installation voltage setpoint U_{1S} or U_{NS}, respectively.

FIGS. 11 and 12 are intended in one example to show the different concepts, namely those on which FIGS. 8 and 9, on the one hand, and FIG. 10, on the other hand, are based.

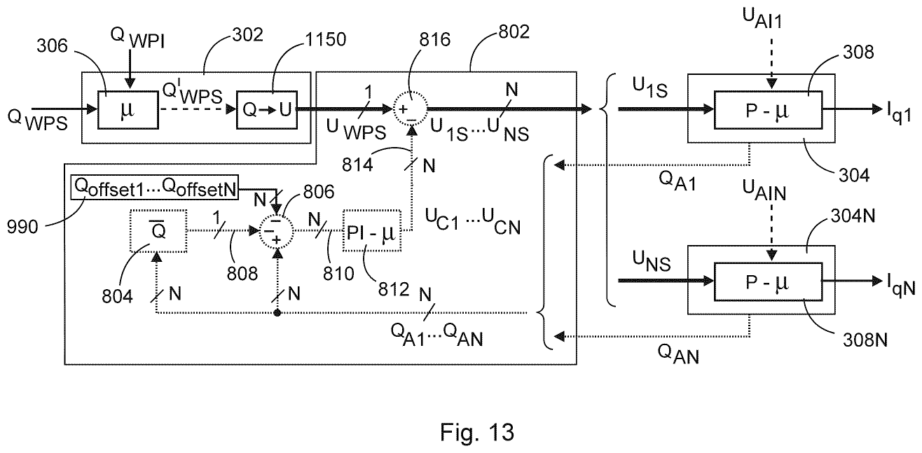

FIG. 13 basically shows the structure of FIG. 9, where the Q-U transform block 1150 according to FIG. 11 is illustrated in the central farm controller 302.

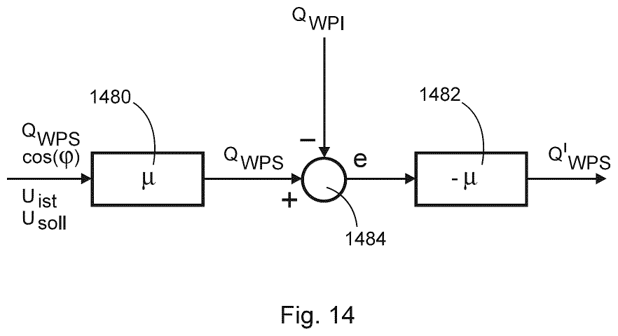

FIG. 14 shows, by way of illustration, function blocks that may be contained in a central farm controller, both 302 and 1302. A farm conversion block 1480 illustrates that a farm target may be stipulated in different ways.

A farm reactive power setpoint Q_{WPS} may in one example be specified directly as a farm target. The farm conversion block 1480 then basically only passes on this value.

A cos (o) may be specified, and then the farm conversion block 1480 may calculate a farm reactive power setpoint Q_{WPS} therefrom, namely as a function of the current currently being fed in.

A setpoint voltage Uₛₒₗₗ may be specified, and then the farm conversion block 1480 may calculate a farm reactive power setpoint Q_{WPS} therefrom.

The farm reactive power setpoint Q_{WPS} may be calculated from a setpoint voltage U_{1S} t using a Q-U characteristic curve, which may be stored in the farm conversion block 1480.

In all cases, the farm reactive power setpoint Q_{WPS} is then used further and compared with a farm reactive power actual value Q_{WPI} at the summing point 1484, such that a control deviation or a control error e arises. The control error e is then transferred to a PI controller 1482, which outputs a modified farm reactive power setpoint Q′_{WPS}. In the ideally adjusted case, the modified farm reactive power setpoint Q′_{WPS} lies above the farm reactive power setpoint Q_{WPS} consumed in the wind farm by a reactive power difference.

In one example, the modified farm reactive power setpoint Q′_{WPS} may correspond to the farm reactive power control value Q_{PSS} (see FIG. 10), if the farm reactive power setpoint Q_{WPS} or else the modified farm reactive power setpoint Q′_{WPS} and the farm reactive power control value Q_{PSS} are output in the form of percentages. The modified farm reactive power control value Q_{PSS} may also be used as an output value to determine the farm voltage setpoint U_{WPS} (see FIGS. 8 and 9).

Generally speaking, according to the present disclosure, the following embodiments are proposed, inter alia, which, unless they are technically contradictory, may be combined with the other aspects described:

What is claimed is:

1. A method for providing a farm reactive power by way of a wind farm containing multiple wind power installations, comprising the following steps:
receiving a farm target value, which characterizes or influences a farm reactive power, used to specify a reactive power to be fed in by the wind farm,
determining a farm control setpoint as a common target value for all wind power installations as a function of the farm target value,
determining an individual installation control setpoint in each case for one of the wind power installations as a function of the farm control setpoint,
determining and outputting an individual installation reactive power or an individual reactive current in each case by way of one of the wind power installations as a function of an installation voltage difference in the form of a difference between an installation actual voltage and an individual installation voltage setpoint of the respective wind power installation, where the individual installation voltage setpoint is determined from the individual installation control setpoint of the respective wind power installation, or corresponds to the individual installation control setpoint, and where
the individual installation control setpoint is determined in each case as a function of the individual installation reactive power of the respective wind power installation and as a function of multiple, in particular all individual installation reactive powers of the wind power installations of the wind farm.

2. The method as claimed in claim 1, wherein
the farm target value is received as a farm reactive power setpoint, and
the farm control setpoint is determined as a farm voltage setpoint used to specify a voltage as a common target value for all wind power installations, and
the individual installation control setpoints are determined as individual installation voltage setpoints.

3. The method as claimed in claim 1, wherein
the farm target value is received as a farm reactive power setpoint, or a farm reactive power setpoint is determined from the farm target value, if the farm target value is not a farm reactive power setpoint,
a modified farm reactive power setpoint is determined from the farm reactive power setpoint using a controller, and
the farm control setpoint is determined as a function of the farm target value by determining the farm control setpoint as a function of the modified farm reactive power setpoint.

4. The method as claimed in one of the preceding claims, wherein
the farm control setpoint is determined as a farm reactive power control setpoint used to specify a reactive power as a common target value for all wind power installations, and
the individual installation control setpoints are determined as installation reactive power setpoints, and/or wherein
at each of the wind power installations, from the respective installation control setpoint, in particular if it is determined as an installation reactive power setpoint,
the respective installation voltage setpoint is determined, in particular by way of a control value transform unit.

5. The method as claimed in one of the preceding claims, wherein
the installation voltage setpoint is determined from each installation control setpoint, in particular when this is determined as an installation reactive power setpoint, in each case using a control value transform function, and the control value transform function has at least one property from the list comprising:
the control value transform function has a low-pass behavior having at least one first main low-pass time constant, where in particular
the first main low-pass time constant has a value in the range of 100 ms to 500 ms,
the control value transform function determines the installation voltage setpoint independently of an installation actual voltage,
the control value transform function limits a gradient of the installation voltage setpoint to a specified gradient limit value and
the control value transform function limits an amplitude of the installation voltage setpoint to a specified amplitude limit value.

6. The method as claimed in one of the preceding claims, wherein
for in each case one of the wind power installations, its installation control value is limited, in particular wherein
an increase in the installation control setpoint thereof is prevented if the individual installation reactive power output thereby or individual reactive current output thereby has reached a predetermined maximum value, which in particular indicates a value that the individual installation reactive power or the individual reactive current is not able to or permitted to exceed, where in particular
the individual installation reactive power output in each case or the individual reactive current that is output is recorded and checked to determine whether the predetermined maximum value is reached and, if the predetermined maximum value is reached, the increase in the installation control setpoint is prevented, in particular the installation control value and/or an offset that influences the installation control value is frozen until the predetermined maximum value has been fallen back below.

7. The method as claimed in one of the preceding claims, wherein
the individual installation control setpoint is determined in each case from the farm control setpoint and an individual control correction value, in particular by subtracting this individual control correction value from the farm control setpoint, where
the individual control correction value is determined as a function of an average difference in the form of a difference between the respective individual installation reactive power and an average of all individual installation reactive powers, where in particular
the average difference used to determine the individual control correction value is given via a controller, in particular a PI controller.

8. The method as claimed in one of the preceding claims, wherein
a or the individual control correction value is determined as a function of an individual installation offset for the respective wind power installation, in particular such that
a or the average difference is taken into consideration, this being determined in the form of a difference between the respective individual installation reactive power and an average of all individual installation reactive powers, where
the individual control correction value is determined as a function of the average difference and the individual offset, in particular such that the individual installation offset is in each case added to the average difference in order to determine a modified average difference and in particular
the modified average difference used to determine the individual control correction value is given via a or the controller, in particular a or the PI controller.

9. The method as claimed in one of the preceding claims, wherein
a sum of all installation offsets is zero and/or
the installation offsets are determined such that installation reactive powers at the wind power installations having different mathematical signs are avoided, that they are in particular determined such that a comparison benchmark does not fall below a comparison limit value that lies between 0.5 and 0.95 or is 1, or is at least not less than 90% of the comparison benchmark than in the case that all installation offsets are zero, where
the comparison benchmark is defined by a ratio of the absolute value of a sum of all installation reactive powers that are fed in to a sum of the absolute values of all installation reactive powers, and/or wherein
a or the individual control correction value, used to determine the respective individual installation control setpoint from the farm control setpoint, is determined in each case such that a sum of all individual installation control setpoints is zero.

10. The method as claimed in one of the preceding claims, wherein
the individual installation reactive power is determined by
counteracting a voltage difference in the form of a difference between the individual installation voltage setpoint and an installation actual voltage present at the respective wind power installation by setting the individual installation reactive power, and/or wherein
the wind power installations each record their output individual installation reactive power as an installation reactive power actual value and transmit it to a central control unit of the wind farm, for use in determining all individual installation control setpoints, and/or wherein
the individual installation reactive power is taken into consideration and/or transmitted in each case as a relative value, in particular a percentage, with respect to a maximum available installation reactive power of the respective wind power installation or a nominal reactive or active power of the respective wind power installation.

11. The method as claimed in one of the preceding claims, wherein
a or the individual control correction value used to determine the respective individual installation control setpoint from the farm control setpoint
is able to be limited by specifying a correction limitation, where,
in order to limit the individual control correction values, the correction limitation is applied to all individual control correction values such that a sum of all individual control correction values remains the same, in particular remains zero, where in particular,
in the case of specifying the correction limitation and if at least one individual control correction value exceeds the correction limitation before it is limited,
a limitation ratio is formed as a ratio between the correction limitation and a maximum control correction value in terms of absolute value, as the greatest value of all individual control correction values prior to a limitation, and
each individual control correction value is multiplied by the limitation ratio in order thereby to form in each case an individual modified control correction value, which is used to determine the respective individual installation control setpoint from the farm control setpoint.

12. The method as claimed in one of the preceding claims, wherein
in the event of a grid fault occurring, in particular in an FRT, LVRT or OVRT case,
at one, some or all wind power installations, statics specifying a relationship between the installation voltage difference and an installation reactive current to be fed in by the respective wind power installation are changed compared to a situation without grid faults, and/or
the determination of the individual installation reactive power or of the individual installation reactive current at one, some or all wind power installations is changed to a simplified alternative method, in which in particular
the wind power installation in question in each case determines an individual installation reactive current as a function of the recorded installation actual voltage present at the respective wind power installation and a fixedly specified voltage setpoint and/or as a function of a reactive current fed in by the wind power installation in question prior to the occurrence of the grid fault, and/or
the alternative method uses changed statics that indicate a relationship between a or the voltage difference and the individual installation reactive current, where in particular,
for the wind power installations that switch to the simplified alternative method, the determination of an individual installation voltage setpoint is frozen until the grid fault has finished and/or until the wind power installations have left the simplified alternative method again, and in particular,
when using a controller having an integral component, the integral component is frozen.

13. The method as claimed in one of the preceding claims, wherein
in the event of a grid fault occurring, in particular in an FRT, LVRT or OVRT case,
if the determination of the individual installation reactive power at one or some, but not all wind power installations is changed to a simplified alternative method,
the determination of the individual installation control setpoints is continued for the wind power installations that have not been changed to the simplified alternative method, where
in order to determine the individual installation control setpoints, a sum of all reactive powers fed in by only those wind power installations that have not been changed to the simplified alternative method is used, and/or wherein
a correction controller used to determine a or the individual control correction value from a or the average difference in the form of a difference between the respective individual installation reactive power and an average of all individual installation reactive powers is parameterized in each case such that
the correction controller is similarly fast or faster than a farm controller used to determine the farm control setpoint, and/or
the correction controller has a control time constant that is at most twice as great as a control time constant of the farm controller, in particular is smaller.

14. A wind farm for providing a farm reactive power by way of multiple wind power installations of the wind farm, wherein the wind farm has a controller that is prepared to carry out a method for providing the farm reactive power, having the following steps:
receiving a farm target value, which characterizes or influences a farm reactive power, used to specify a farm reactive power to be fed in by the wind farm,
determining a farm control setpoint as a common target value for all wind power installations as a function of the farm target value,
determining an individual installation control setpoint in each case for one of the wind power installations as a function of the farm control setpoint,
determining and outputting an individual installation reactive power in each case by way of one of the wind power installations as a function of an installation voltage difference in the form of a difference between an installation actual voltage and an individual installation voltage setpoint of the respective wind power installation, where the individual installation voltage setpoint is determined from the individual installation control setpoint of the respective wind power installation, or corresponds to the individual installation control setpoint, and where
the individual installation control setpoint is determined in each case as a function of the individual installation reactive power of the respective wind power installation and as a function of multiple, in particular all individual installation reactive powers of the wind power installations of the wind farm.

15. The wind farm as claimed in claim 14, wherein it includes a central farm control unit and multiple installation controllers, where
in each case one of the installation controllers is arranged on a respective wind power installation,
the installation controllers are connected to the central farm control unit via a communication system, in particular via a data bus system, and
a method for providing the farm reactive power is implemented on the central farm control unit and the multiple installation controllers, and/or wherein
the wind farm is prepared to carry out a method as claimed in one of claims 1 to 13 and/or wherein
a method as claimed in one of claims 1 to 13 is implemented in the central farm control unit and the multiple installation controllers.
